(19) United States
(12) Patent Application Publication
(10) Pub. No.: US 2024/0322185 A1
(43) Pub. Date: Sep. 26, 2024

(54) ELECTRODE, SECONDARY BATTERY, BATTERY PACK, AND VEHICLE

(71) Applicant: KABUSHIKI KAISHA TOSHIBA, Tokyo (JP)

(72) Inventors: Hirofumi YASUMIISHI, Kawasaki Kanagawa (JP); Tetsuya SASAKAWA, Yokohama Kanagawa (JP); Yuiko KOITABASHI, Yokohama Kanagawa (JP); Sayaka MORIMOTO, Kawasaki Kanagawa (JP)

(73) Assignee: KABUSHIKI KAISHA TOSHIBA, Tokyo (JP)

(21) Appl. No.: 18/488,461

(22) Filed: Oct. 17, 2023

(30) Foreign Application Priority Data
Mar. 22, 2023 (JP) 2023-045822

(51) Int. Cl. H01M 4/62; B60L 3/00; H01M 4/36; H01M 4/485; H01M 10/42; H01M 50/204; H01M 50/249; H01M 50/296

(52) U.S. Cl. CPC H01M 4/628; B60L 3/0046; H01M 4/366; H01M 4/485; H01M 10/425; H01M 50/204; H01M 50/249; H01M 50/296; B60L 7/10; H01M 2004/021; H01M 2004/027; H01M 2220/20; H02P 3/14

(57) ABSTRACT

In general, according to an embodiment, an electrode is provided. The electrode includes: inorganic particles; niobium titanium oxide particles; and an inorganic particle-containing layer covering at least a part of surfaces of the niobium titanium oxide particles. An average particle size of the inorganic particles is larger than a thickness of the inorganic particle-containing layer.

### CROSS-REFERENCE TO RELATED APPLICATIONS

This application is based upon and claims the benefit of priority from Japanese Patent Application No. 2023-045822, filed Mar. 22, 2023, the entire contents of which are incorporated herein by reference.

### FIELD

Embodiments described herein relate generally to an electrode, a secondary battery, a battery pack, and a vehicle.

### BACKGROUND

In a nonaqueous electrolyte battery such as a lithium ion secondary battery, there is a problem that the discharge capacity of an electrode decreases with a charge-discharge cycle.

### BRIEF DESCRIPTION OF THE DRAWINGS

FIG. 1 is a cross-sectional view schematically illustrating an example of an electrode according to an embodiment.

FIG. 2 is an enlarged view illustrating vicinity of an active material particle in the example of the electrode according to the embodiment.

FIG. 3 is a cross-sectional view schematically illustrating an example of an electrode according to a reference example.

FIG. 4 is a view schematically illustrating an HAADF-STEM image of a first particle.

FIG. 5 is a cross-sectional view schematically illustrating an example of a secondary battery according to an embodiment.

FIG. 6 is an enlarged cross-sectional view of a section A of the secondary battery illustrated in FIG. 5.

FIG. 7 is a partially cut-out perspective view schematically illustrating another example of the secondary battery according to the embodiment.

FIG. 8 is an enlarged cross-sectional view of a section B of the secondary battery illustrated in FIG. 7.

FIG. 9 is a perspective view schematically illustrating an example of a battery module according to an embodiment.

FIG. 10 is an exploded perspective view schematically illustrating an example of a battery pack according to an embodiment.

FIG. 11 is a block diagram illustrating an example of an electric circuit of the battery pack illustrated in FIG. 10.

FIG. 12 is a partially see-through diagram schematically illustrating an example of a vehicle according to an embodiment.

FIG. 13 is a diagram schematically illustrating an example of a control system related to an electric system in the vehicle according to the embodiment.

### DETAILED DESCRIPTION

In general, according to an embodiment, an electrode is provided. The electrode includes: inorganic particles; niobium titanium oxide particles; and an inorganic particle-containing layer covering at least a part of surfaces of the niobium titanium oxide particles. An average particle size of the inorganic particles is larger than a thickness of the inorganic particle-containing layer.

According to another embodiment, a secondary battery including the electrode of the embodiment is provided.

According to another embodiment, a battery pack including the secondary battery of the embodiment is provided.

According to another embodiment, a vehicle including the battery pack of the embodiment is provided.

Hereinafter, embodiments will be described with reference to the drawings as appropriate. The same reference signs are applied to common components throughout the embodiments and overlapped explanations are thereby omitted. Each drawing is a schematic view for encouraging explanations of the embodiment and understanding thereof, and thus there are some details in which a shape, a size and a ratio are different from those in an actual device; they can however be appropriately design-changed, taking into account the following explanations and known technology.

### First Embodiment

One of factors that reduce cycle performance and output performance of the electrode is deterioration in niobium titanium oxide in the electrode. Deterioration in niobium titanium oxide may occur, for example, upon contact, with the niobium titanium oxide, of hydrofluoric acid generated by a side reaction.

As a result of intensive studies, the present inventors have found that inorganic particles can trap hydrofluoric acid. However, the mere inclusion of the inorganic particles in the electrode cannot avoid the deterioration in niobium titanium oxide in a case where hydrofluoric acid approaches the niobium titanium oxide without being trapped by the inorganic particles.

As a result of further research based on this result, the electrode according to the first embodiment has been realized.

According to a first embodiment, an electrode is provided. The electrode according to the first embodiment includes: inorganic particles; niobium titanium oxide particles; and an inorganic particle-containing layer covering at least a part of surfaces of the niobium titanium oxide particles. An average particle size of the inorganic particles is larger than a thickness of the inorganic particle-containing layer.

Each of the inorganic particles and the inorganic particle-containing layer can trap hydrofluoric acid.

Therefore, the inorganic particles can suppress hydrofluoric acid from approaching the niobium titanium oxide particles. Even in a case where hydrofluoric acid approaches the niobium titanium oxide particles without being trapped by the inorganic particles, the inorganic particle-containing layer can trap hydrofluoric acid. Therefore, according to the electrode, it is possible to suppress contact of hydrofluoric acid with the niobium titanium oxide particles, and, as a result, to suppress deterioration in niobium titanium oxide. This contributes to improvement in cycle performance and output performance.

Furthermore, in the electrode, the average particle size of the inorganic particles is larger than the thickness of the inorganic particle-containing layer. Therefore, the average particle size of the inorganic particles is not too small, and thus the inorganic particles are less likely to aggregate in a manufacturing process of the electrode. Therefore, the inorganic particles can be uniformly present in the electrode, and thus hydrofluoric acid can be efficiently trapped. As a result, deterioration in niobium titanium oxide can be suppressed. This contributes to improvement in cycle performance and output performance.

In addition, the thickness of the inorganic particle-containing layer is smaller than the average particle size of the inorganic particles. Therefore, it is possible to suppress a decrease in ion conductivity due to an excessively thick inorganic particle-containing layer. As a result, the output performance can be enhanced.

A thick inorganic particle-containing layer tends to result in an increase in hydrofluoric acid trapping ability, but may provide a lower electron conductivity of the active material particles than that in a case of a thin inorganic particle-containing layer.

On the other hand, as the average particle size of the inorganic particles is larger, aggregation of the inorganic particles can be suppressed, so that the inorganic particles tend to be uniformly dispersed in the electrode. The electrode may further include an electro-conductive agent. By suppressing aggregation of the inorganic particles, the electro-conductive agent is less likely to be adsorbed onto the inorganic particles, so that dispersibility of the electro-conductive agent can be improved. This contributes to improvement in output performance. Therefore, even in a case where the inorganic particle-containing layer is thick, the output performance as an electrode can be kept high by combining it with inorganic particles having a large average particle size.

In the electrode, the average particle size of the inorganic particles is larger than the thickness of the inorganic particle-containing layer. Therefore, the effect for improving the output performance due to high dispersibility of the inorganic particles and the electro-conductive agent, against the decrease in electron conductivity due to the increase in thickness of the inorganic particle-containing layer, is large. Therefore, the output performance can be kept high.

In a case where the inorganic particle-containing layer is thin, the electron conductivity of the active material particles can be kept high. Therefore, as long as the average particle size of the inorganic particles is larger than the thickness of the inorganic particle-containing layer, even in a case where the inorganic particle-containing layer is combined with inorganic particles having a relatively small average particle size, the effect for improving the electron conductivity due to the thin inorganic particle-containing layer, against the decrease in output performance due to the small average particle size of the inorganic particles, can be increased. Therefore, the output performance as an electrode can be kept high.

Hereinafter, the electrode according to the embodiment will be described in detail with reference to the drawings.

The electrode can be, for example, for a nonaqueous electrolyte battery. The nonaqueous electrolyte battery can be, for example, a nonaqueous electrolyte battery using an alkali metal ion as a carrier ion. For example, the battery may be a lithium battery (lithium ion battery). The electrode can be, for example, for a secondary battery.

In a manufacturing process of the nonaqueous electrolyte battery, water is likely to be mixed as an inevitable impurity. In a case where a nonaqueous electrolyte containing a fluorine atom is used as a nonaqueous electrolyte to be combined with the electrode, a side reaction occurs between water and the nonaqueous electrolyte, so that hydrofluoric acid (hydrogen fluoride, HF) can be generated as a decomposition product of the nonaqueous electrolyte. Details of the nonaqueous electrolyte will be described later.

Upon contact of hydrofluoric acid with the material included in the electrode, a transition metal may be eluted, for example. The eluted transition metal may be deposited, for example, on the electrode. In addition, the hydrofluoric acid can react with an electrolyte to form lithium fluoride in a case where the electrode is combined with the electrolyte. The lithium fluoride may be deposited, for example, on the electrode. These materials deposited on the electrode may cause an increase in resistance.

The electrode includes inorganic particles and an inorganic particle-containing layer. Therefore, elution of a transition metal and formation of lithium fluoride can be suppressed. Therefore, the output performance of the electrode can be improved.

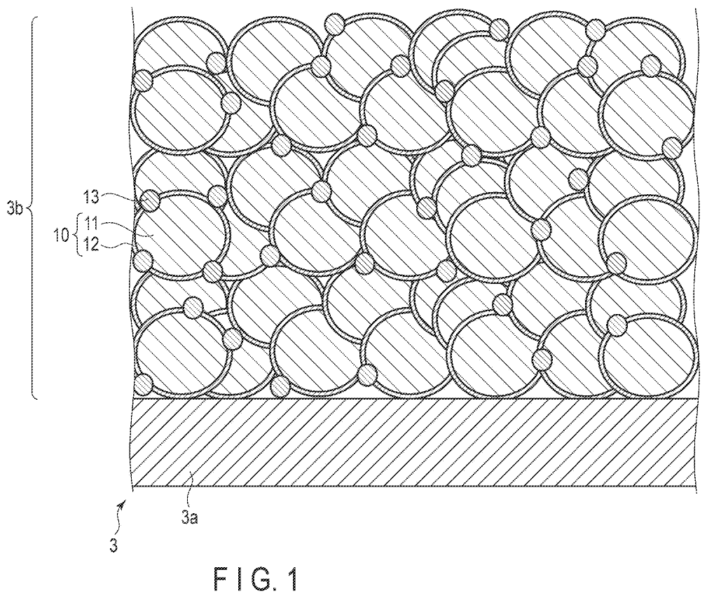

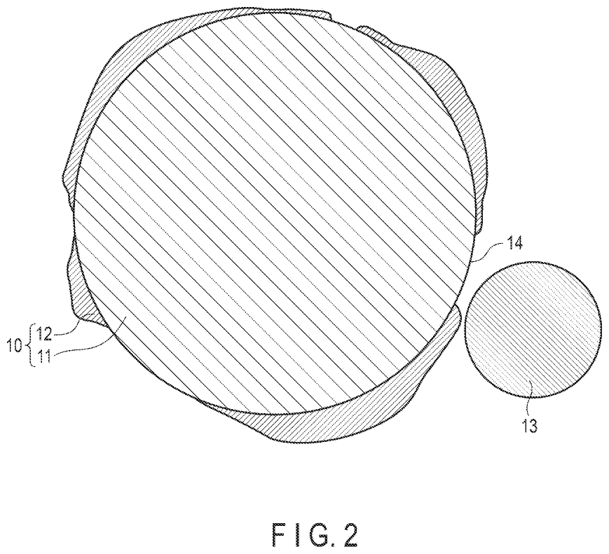

FIG. 1 is a cross-sectional view schematically illustrating an example of the electrode. FIG. 2 is an enlarged view illustrating vicinity of an active material particle in the example of the electrode. In FIGS. 1 and 2, an electro-conductive agent and a binder that may be included in an active material-containing layer are not depicted for the sake of convenience.

An electrode 3 includes a current collector 3a and an active material-containing layer 3b formed on the current collector 3a. The active material-containing layer 3b includes first particles 10 and inorganic particles 13. The first particles 10 include niobium titanium oxide particles 11 and an inorganic particle-containing layer 12 covering at least a part of surfaces of the niobium titanium oxide particles 11.

As illustrated in FIG. 2, the first particle 10 may include an exposed portion 14. The exposed portion 14 is a portion of the surface of the niobium titanium oxide particle 11 that is not covered with the inorganic particle-containing layer 12. In other words, the exposed portion 14 is a portion of the surface of the first particle 10 where the surface of the niobium titanium oxide particle 11 is exposed. Although the first particle 10 illustrated in FIG. 2 includes the exposed portion 14, the first particle 10 may not include the exposed portion. That is, the entire surfaces of the niobium titanium oxide particles 11 may be covered with the inorganic particle-containing layer 12.

The first particle 10 preferably includes the exposed portion 14, since the ion conductivity can be kept high, and the output performance can be improved.

In a case where the first particle 10 includes the exposed portion 14, at least a part of the surfaces of the niobium titanium oxide particles 11 may be exposed on a surface of the electrode 3. The surface of the electrode 3 may be a principal surface on a side not in contact with the current collector 3a out of principal surfaces of the active material-containing layer 3b.

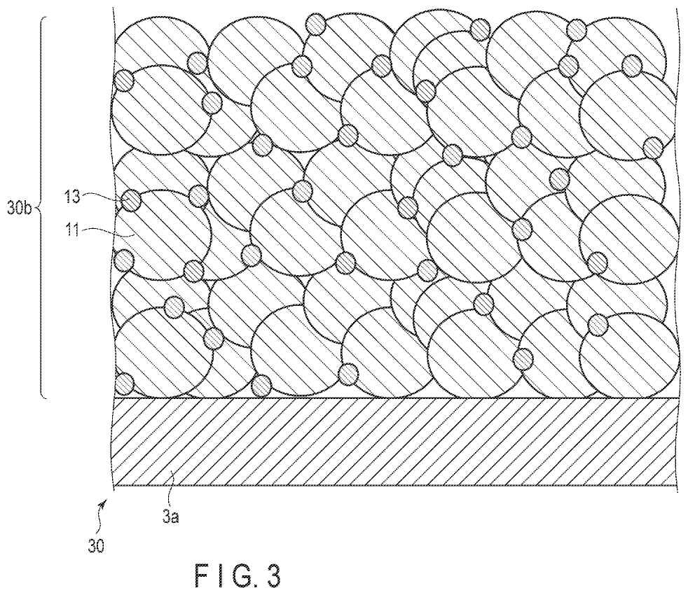

An electrode according to a reference example will be described with reference to FIG. 3.

FIG. 3 is a cross-sectional view schematically illustrating an example of the electrode according to the reference example. In FIG. 3, an electro-conductive agent and a binder that may be included in an active material-containing layer are not depicted for the sake of convenience. An electrode 30 according to the reference example includes a current collector 3a and an active material-containing layer 30b formed on the current collector 3a. The active material-containing layer 30b includes niobium titanium oxide particles 11 and inorganic particles 13.

As illustrated in FIG. 3, in the electrode 30 according to the reference example, no inorganic particle-containing layer is present on surfaces of the niobium titanium oxide particles 11. Therefore, the entire surfaces of the niobium titanium oxide particles 11 are exposed. Therefore, in a case where hydrofluoric acid not trapped by the inorganic particles 13 approaches the niobium titanium oxide particles 11, the hydrofluoric acid can come into contact with the surfaces of the niobium titanium oxide particles 11. As a result, the niobium titanium oxide particles may be deteriorated.

Hereinafter, the electrode according to the embodiment will be described in more detail.

The electrode according to the embodiment can include a current collector and an active material-containing layer. The active material-containing layer can be formed on one side or both sides of the current collector. The active material-containing layer includes first particles and inorganic particles. The first particles include niobium titanium oxide particles and an inorganic particle-containing layer covering at least a part of surfaces of the niobium titanium oxide particles.

Niobium titanium oxide can function as an active material. The first particles include niobium titanium oxide particles, and thus may be active material particles. The active material-containing layer may include the first particles singly as the active material, or may include a mixture of the first particles and one or two or more other active materials.

The active material-containing layer can include an active material including the first particles, inorganic particles, and optionally an electro-conductive agent and a binder.

An average particle size of the first particles including the niobium titanium oxide particles and the inorganic particle-containing layer is preferably in a range of 0.5 μm or more and 2.0 μm or less. If the average particle size of the first particles is 0.5 μm or more, surface energy of the first particles can be reduced, and thus, for example, aggregation at the time of a dispersion step in slurry preparation can be suppressed. When the average particle size of the first particles is 2.0 μm or less, in-solid diffusibility of Li⁺ in the first particles can be enhanced. Therefore, in-solid diffusibility of Li⁺ in the active material can be enhanced.

An example of the niobium titanium oxide included in the niobium titanium oxide particles is monoclinic niobium titanium oxide.

An example of the monoclinic niobium titanium oxide is a compound represented by LiₓTi_{1-y}M1_{y}Nb_{2-z}M2_{z}O_{7+δ}. Here, M1 is at least one selected from the group consisting of Zr, Si, and Sn. M2 is at least one selected from the group consisting of V, Ta, and Bi. The respective subscripts in the composition formula are as follows: 0≤x≤5, 0≤y<1, 0≤z<2, and −0.3≤δ≤0.3. A specific example of the monoclinic niobium titanium oxide is LiₓNb₂TiO₇ (0≤x≤5).

Another example of the monoclinic niobium titanium oxide is a compound represented by LiₓTi_{1-y}M3_{y+z}Nb_{2-z}O_{7-δ}. Here, M3 is at least one selected from Mg, Fe, Ni, Co, W, Ta, and Mo. The respective subscripts in the composition formula are as follows: 0≤x≤5, 0≤y<1, 0≤z<2, and −0.3≤δ≤0.3.

The form of the inorganic particle-containing layer is not particularly limited, and may be, for example, a form in which particles containing an inorganic material are aggregated on the surfaces of the niobium titanium oxide particles and cover at least a part of the surfaces of the niobium titanium oxide particles. The particles containing the inorganic material may be primary particles or may be in the form of secondary particles in which primary particles are aggregated.

The inorganic particle-containing layer may cover at least a part of the surfaces of the niobium titanium oxide particles, or may cover the entire surfaces of the niobium titanium oxide particles. In a case where the inorganic particle-containing layer does not cover the entire surfaces of the niobium titanium oxide particles, the surfaces of the niobium titanium oxide particles may include a portion not covered with the inorganic particle-containing layer. In a case where the surfaces of the niobium titanium oxide particles include a portion not covered with the inorganic particle-containing layer, at least a part of the portion not covered with the inorganic particle-containing layer may be exposed on a surface of the electrode. In other words, the inorganic particle-containing layer covers a part of surfaces of the niobium titanium oxide particles. At least a part of a portion other than the part of surfaces of the niobium titanium oxide particles is exposed on a surface of the electrode.

A thickness of the inorganic particle-containing layer is in a range of 0.0005 μm or more and 0.7 μm or less. The thickness of the inorganic particle-containing layer is preferably in a range of 0.001 μm or more and 0.4 μm or less. A thickness of the inorganic particle-containing layer of 0.001 μm or more can enhance durability against hydrofluoric acid. Specifically, the amount of hydrofluoric acid that can be trapped by the inorganic particle-containing layer increases, thereby making it possible to suppress contact, with the niobium titanium oxide particles, of hydrofluoric acid exceeding the amount of hydrofluoric acid that can be trapped by the inorganic particle-containing layer. A thickness of the inorganic particle-containing layer of 0.4 μm or less can suppress an increase in resistance. A lower limit of the thickness of the inorganic particle-containing layer can be, for example, 0.0010 μm.

The thickness of the inorganic particle-containing layer is more preferably in a range of 0.01 μm or more and 0.35 μm or less. The thickness of the inorganic particle-containing layer is further preferably in a range of 0.05 μm or more and 0.3 μm or less.

A mass of the inorganic particle-containing layer is preferably in a range of 1 mass % or more and 20 mass % or less relative to a mass of the niobium titanium oxide particles. If the mass is 1 mass % or more, contact of hydrogen fluoride with the niobium titanium oxide particles can be suppressed. If the mass is 20 mass % or less, an increase in interface resistance can be suppressed.

The particles containing the inorganic material preferably include at least one selected from the group consisting of solid electrolyte-containing particles, and particles including a metal oxide containing at least one element selected from the group consisting of Al, Ti, Si, Zr, and Mg.

The inorganic particle-containing layer may include the particles including the metal oxide singly, may contain the solid electrolyte-containing particles singly, or may contain both the particles including the metal oxide and the solid electrolyte-containing particles. The type of the particles including the metal oxide used can be one or two or more. The type of the solid electrolyte-containing particles can be one or two or more.

The particles including the metal oxide may further include a solid electrolyte. The solid electrolyte-containing particles may further include a metal oxide.

Examples of the metal oxide can include Al₂O₃, TiO₂, SiO₂, ZrO₂, and MgO. The type of the metal oxide can be one or two or more.

The solid electrolyte is a solid substance having Li ion conductivity. Having Li ion conductivity, as referred to herein, indicates exhibiting a lithium ion conductivity of 1×10⁻⁶ S/cm or more at 25° C. Examples of the solid electrolyte can include oxide solid electrolytes and sulfide solid electrolytes. Specific examples of the solid electrolyte will be described below.

A lithium phosphate solid electrolyte having a sodium (Na) super ionic conductor (NASICON) structure can be used as the oxide solid electrolyte. For example, a lithium phosphate solid electrolyte represented by a general formula Li₁₊ₓMα₂(PO₄)₃. Mα in the above general formula is, for example, one or more selected from the group consisting of titanium (Ti), germanium (Ge), strontium (Sr), zirconium (Zr), tin (Sn), aluminum (Al), and calcium (Ca). The subscript x is in a range of 0≤x≤2.

Other examples of the lithium phosphate solid electrolyte having the NASICON structure can include an LATP compound represented by Li₁₊ₓAlₓTi₂₋ₓ(PO₄)₃ where 0.1≤x≤0.5; a compound represented by Li₁₊ₓAl_{y}Mβ_{2-y}(PO₄)₃ where Mβ is one or more selected from the group consisting of Ti, Ge, Sr, Zr, Sn, and Ca, 0≤x≤1, and 0≤y≤1; a compound represented by Li₁₊ₓAlₓGe₂₋ₓ(PO₄)₃ where 0≤x≤2; a compound represented by Li₁₊ₓAlₓZr₂₋ₓ(PO₄)₃ where 0≤x≤2; a compound represented by Li_{1+x+y}AlₓMγ₂₋ₓSi_{y}P_{3-y}O₁₂ where Mγ is one or more selected from the group consisting of Ti and Ge, 0<x≤2, and 0≤y<3; and a compound represented by Li₁₊₂ₓZr₁₋ₓCaₓ(PO₄)₃ where 0≤x<1.

In addition to the above lithium phosphate solid electrolyte, examples of the oxide solid electrolyte include amorphous LIPON compounds represented by LiₓPO_{y}N_{z} where 2.6≤x≤3.5, 1.9≤y≤3.8, and 0.1≤z≤1.3 (e.g., Li_{2.9}PO_{3.3}N_{0.46}); a compound having a garnet structure represented by La₅₊ₓAₓLa₃₋ₓMδ₂O₁₂ where A is one or more selected from the group consisting of Ca, Sr, and Ba, Mδ is one or more selected from the group consisting of Nb and Ta, and 0≤x≤0.5; a compound represented by Li₃Mδ₂₋ₓL₂O₁₂ where Mδ is one or more selected from the group consisting of Nb and Ta, L may include Zr, and 0≤x≤0.5; a compound represented by Li₇₋₃ₓAlₓLa₃Zr₃O₁₂ where 0≤x≤0.5; an LLZ compound represented by Li₅₊ₓLa₃Mδ₂₋ₓZrₓO₁₂ where Mδ is one or more selected from the group consisting of Nb and Ta, and 0≤x≤2 (e.g., Li₇La₃Zr₂O₁₂); and a compound having a perovskite structure and represented by La_{2/3-x}LiₓTiO₃ where 0.3≤x≤0.7.

One or more among the above compounds may be used as the solid electrolyte. Two or more of the above solid electrolytes may be used.

The inorganic particle-containing layer preferably includes the solid electrolyte-containing particles. The inorganic particle-containing layer including the solid electrolyte-containing particles can have high ion conductivity. Therefore, the output performance can be enhanced.

For example, in a case where the electrode according to the embodiment includes the first particles as a negative electrode active material, examples of other active materials include lithium titanate having a ramsdellite structure (e.g., Li_{2+y}Ti₃O₇, 0≤y<3), lithium titanate having a spinel structure (e.g., Li₄₊ₓTi₅O₁₂, 0≤x≤3), titanium dioxide (TiO₂), anatase titanium dioxide, rutile titanium dioxide, niobium pentoxide (Nb₂O₅), hollandite titanium composite oxide, orthorhombic titanium composite oxide, and monoclinic niobium titanium oxide. As the monoclinic niobium titanium oxide, for example, the same ones as described above can be used.

Examples of the orthorhombic titanium-containing composite oxide as described above include a compound represented by Li₂₊ₐM^{I}_{2-b}Ti_{6-c}M^{II}_{d}O_{14+σ}. Here, M^{I} is at least one selected from the group consisting of Sr, Ba, Ca, Mg, Na, Cs, Rb and K. M^{II} is at least one selected from the group consisting of Zr, Sn, V, Nb, Ta, Mo, W, Y, Fe, Co, Cr, Mn, Ni and Al. The respective subscripts in the composition formula are as follows: 0≤a≤6, 0≤b<2, 0≤c<6, 0≤d<6, and −0.5≤σ≤0.5. A specific example of the orthorhombic titanium-containing composite oxide is Li₂₊ₐNa₂Ti₆O₁₄ (0≤a≤6).

An average particle size of the inorganic particles can be in a range of 0.3 μm or more and 2.0 μm or less. The average particle size of the inorganic particles is preferably in a range of 0.4 μm or more and 1.0 μm or less. An average particle size of the inorganic particles of 0.4 μm or more can increase an amount of hydrofluoric acid that can be trapped by each one inorganic particle. Further, in the manufacturing process of the electrode, aggregation of the inorganic particles can be suppressed, so that the inorganic particles can be uniformly dispersed in the electrode. An average particle size of the inorganic particles of 1.0 μm or less can increase the number of inorganic particles per mass. In addition, the inorganic particles can be uniformly distributed also in fine gaps in the electrode. Therefore, the inorganic particles having an average particle size in the range of 0.4 μm or more and 1.0 μm or less can efficiently trap hydrofluoric acid.

The average particle size of the inorganic particles is more preferably in a range of 0.4 μm or more and 0.9 μm or less. The average particle size of the inorganic particles is further preferably in a range of 0.4 μm or more and 0.8 μm or less.

The inorganic particles may be primary particles, secondary particles in which primary particles are aggregated, or a mixture of primary particles and secondary particles.

The inorganic particles preferably include at least one selected from the group consisting of a solid electrolyte, and a metal oxide containing at least one element selected from the group consisting of Al, Ti, Si, Zr, and Mg. Among the above ones, the inorganic particles may include the metal oxide alone, may include the solid electrolyte alone, or may include both the metal oxide and the solid electrolyte.

As the metal oxide and the solid electrolyte, those of the types described above can be used.

The inorganic particles preferably include a solid electrolyte. The inorganic particles including the solid electrolyte can have high ion conductivity. Therefore, the output performance of the electrode can be enhanced.

The inorganic particles and the inorganic particle-containing layer may be made of the same substance or may include substances different from each other. Preferably, the inorganic particles include a solid electrolyte, and the inorganic particle-containing layer includes solid electrolyte-containing particles.

The electro-conductive agent is blended to enhance current collection performance and to suppress contact resistance between the active material and the current collector. Examples of the electro-conductive agent include carbonaceous substances such as vapor grown carbon fiber (VGCF), carbon blacks such as acetylene black, graphite, carbon nanotubes, and carbon nanofibers. One of these may be used as the electro-conductive agent, or two or more may be used in combination as the electro-conductive agent. Alternatively, instead of using the electro-conductive agent, a carbon coat or an electronically conductive inorganic material coat may be applied to the surfaces of the active material particles.

The binder is blended to fill gaps among the dispersed active material and also to bind the active material with the current collector. Examples of the binder include polytetrafluoro ethylene (PTFE), polyvinylidene fluoride (PVdF), fluorine rubber, styrene-butadiene rubber (SBR), polyacrylic acid compounds, imide compounds, carboxymethyl cellulose (CMC), and salts of CMC. One of these may be used as the binder, or alternatively, two or more may be used in combination as the binder.

Blending proportions of the active material, inorganic particles, electro-conductive agent and binder in the active material-containing layer may be appropriately changed according to the use of the electrode. For example, in a case of using the electrode as a negative electrode of a secondary battery, the active material (negative electrode active material), inorganic particles, electro-conductive agent and binder are preferably blended in proportions of 68 mass % or more and 96 mass % or less, 1 mass % or more and 10 mass % or less, 2 mass % or more and 30 mass % or less, and 2 mass % or more and 30 mass % or less, respectively. An amount of the inorganic particles is set to 1 mass % or more, so that a hydrofluoric acid trapping effect can be secured. An amount of the electro-conductive agent is set to 2 mass % or more, so that the current collection performance of the active material-containing layer can be improved. An amount of binder is set to 2 mass % or more, so that binding between the active material-containing layer and the current collector is sufficient, whereby excellent cycling performances can be expected. On the other hand, the amount of the inorganic particles is preferably 10 mass % or less from the viewpoint of ensuring electron conductivity. An amount of each of the electro-conductive agent and the binder is preferably 30 mass % or less, in view of increasing the capacity.

A proportion of the first particles in the active material is preferably 80 mass % or more. The proportion of the first particles in the active material can be 100 mass %.

There may be used for the current collector, a material which is electrochemically stable at a potential at which lithium (Li) is inserted into and extracted from the active material. For example, in a case where the active material is used as the negative electrode active material, the current collector is preferably made of copper, nickel, stainless steel, aluminum, or an aluminum alloy including one or more elements selected from the group consisting of Mg, Ti, Zn, Mn, Fe, Cu, and Si. A thickness of the current collector is preferably 5 μm or more and 20 μm or less. The current collector having such a thickness can achieve a balance between strength and weight reduction of the electrode.

In addition, the current collector can include a portion where the active material-containing layer is not formed, on a surface thereof. This portion can serve as a current-collecting tab.

### <Method for Fabricating Electrode>

The electrode may be fabricated by the following method, for example.

First particles including niobium titanium oxide particles and an inorganic particle-containing layer are fabricated. Next, an active material including the first particles, inorganic particles, an electro-conductive agent, and a binder are suspended in a solvent to prepare a slurry. As the solvent for the slurry, for example, water or N-methylpyrrolidone (NMP) can be used. The slurry is applied onto one side or both sides of a current collector. Then, the applied slurry is dried to obtain a stack of an active material-containing layer and the current collector. Then, the stack is subjected to pressing. The electrode is fabricated in this manner.

Stirring with a bead mill may be performed at the time of suspension in the preparation of the slurry. When an exposed portion is formed in the fabrication of the first particles which will be described later, stirring conditions for suspension are preferably set to a glass bead diameter of about 2 mm, a filling rate of about 50%, a stirring speed of about 3000 rpm, and a stirring time of about 1 hour. Since stirring strength is not too strong due to the use of the above conditions, it is possible to suppress the inorganic particle-containing layer from becoming too thin due to excessive scraping of the first particles.

Alternatively, the electrode may be fabricated by the following method. First, an active material including the first particles, inorganic particles, an electro-conductive agent, and a binder are mixed to obtain a mixture. Next, the mixture is formed into pellets. Then, the electrode can be obtained by disposing the pellets onto the current collector.

### (Method for Fabricating First Particle)

The first particles can be fabricated, for example, as follows.

First, an inorganic particle-containing layer precursor is dissolved or dispersed in a solvent to prepare an inorganic particle-containing layer precursor solution.

As the solvent, for example, water can be used. Nitric acid and polyvinyl alcohol (PVA) may be further added to the solvent. The addition of nitric acid makes it easy to dissolve a metal element contained in the inorganic particle-containing layer precursor in the solvent. The addition of PVA can keep dispersibility. Concentrations of nitric acid and PVA can be in a range of 0.01 mass % or more and 0.05 mass % or less and a range of 0.1 mass % or more and 20 mass % or less, respectively.

As the inorganic particle-containing layer precursor, a material including an element contained in a desired inorganic particle-containing layer can be used. For example, an alkoxide or a nitric acid salt including a metal element contained in the desired inorganic particle-containing layer can be used. In a case where the desired inorganic particle-containing layer includes phosphorus (P) in the composition, for example, ammonium dihydrogen phosphate can be used as a phosphorus (P) source. These materials are mixed at a molar ratio so as to achieve a desired composition of the inorganic particle-containing layer, and dissolved or dispersed in a solvent, whereby an inorganic particle-containing layer precursor solution can be obtained.

Niobium titanium oxide particles are added to the inorganic particle-containing layer precursor solution and stirred to prepare a dispersion. The solvent is removed from the dispersion after stirring to obtain a dry powder. The first particles in which the inorganic particle-containing layer is formed on the surfaces of the niobium titanium oxide particles can be fabricated by firing the dry powder.

Mixing proportions of the inorganic particle-containing layer precursor solution and the niobium titanium oxide particles can be set to, for example, proportions such that the mass of the inorganic particle-containing layer obtained after firing is 1 mass % or more and 20 mass % or less relative to the mass of the niobium titanium oxide particles. If the mass of the inorganic particle-containing layer is 1 mass % or more, the inorganic particle-containing layer can be easily formed after firing. If the mass is 20 mass % or less, formation of an excessive inorganic particle-containing layer can be suppressed.

Firing conditions are not particularly limited, but a firing temperature is preferably 600° C. or higher and 1000° C. or lower. A firing time is preferably 5 hours or longer and 10 hours or shorter. The firing time can be changed according to the firing temperature.

### (Formation of Exposed Portion)

An exposed portion may be formed in the first particles obtained as described above. The exposed portion can be formed, for example, by subjecting the first particles to a bead mill. As the bead mill, for example, a wet bead mill can be used.

Bead milling for forming the exposed portion can be performed under the following conditions, for example. A diameter of glass beads used in the bead mill is preferably in a range of 2 mm or more and 10 mm or less. A diameter of the glass beads of 2 mm or more can secure pulverization force. A diameter of the glass beads of 10 mm or less can enhance pulverization efficiency. A filling rate of the glass beads in the bead mill is preferably in a range of 50% or more and 80% or less. A filling rate of the glass beads of 50% or more can enhance the pulverization efficiency. A filling rate of the glass beads of 80% or less results in high moving efficiency of the beads, and, as a result, can enhance the pulverization efficiency. Bead milling is preferably performed at 1000 rpm or more and 3000 rpm or less. A speed of 1000 rpm or more can enhance the pulverization efficiency. A speed of 3000 rpm or less can suppress excessive pulverization of the first particles. A stirring time is preferably 30 minutes or longer and 60 minutes or shorter. If the stirring time is 30 minutes or longer, the exposed portion can be easily formed. If the time is 60 minutes or shorter, excessive pulverization of the first particles can be suppressed.

The first particles having the exposed portion formed in advance can be used in the preparation of the slurry described above. Alternatively, the exposed portion can be formed simultaneously with the preparation of the slurry as follows.

First, first particles in which exposed portion is not formed and inorganic particles are added to a solvent, and first bead milling is performed. By setting conditions for the first bead milling to the above-described conditions for forming the exposed portion, the exposed portion is formed in the first particles. Next, an electro-conductive agent and CMC as a binder are added, and second bead milling is performed. The stirring conditions for suspension described above are used as conditions for the second bead milling. Finally, a type of binder other than CMC is further added and stirred, whereby a slurry can be prepared. Alternatively, a slurry can be prepared by adding an active material including the first particles in which exposed portion is not formed, inorganic particles, an electro-conductive agent, and a binder to a solvent, and performing bead milling under the conditions for forming the exposed portion. A slurry containing the first particles including the exposed portion can be prepared in the above manner.

### <Various Measurement Methods for Active Material>

Next, methods for measuring the composition and structure of the active material will be described.

In a case where an active material included in an electrode incorporated in a battery is measured, the electrode is extracted from the battery as follows, and then the active material is extracted from the electrode and subjected to measurement.

### (Extraction of Electrode)

First, lithium ions are completely extracted from the niobium titanium oxide included in the electrode. For example, in a case where measurement is performed on a negative electrode, the battery is completely discharged. However, even in the completely discharged battery, lithium ions may slightly remain in the niobium titanium oxide particles in the negative electrode.

Next, the battery is disassembled in a glove box filled with argon, and the electrode including the active material to be measured is extracted. The extracted electrode is washed with an appropriate solvent. If the battery is a nonaqueous electrolyte battery, the solvent used here is preferably an organic solvent included in the nonaqueous electrolyte, for example, ethyl methyl carbonate.

### (Extraction of Active Material)

The extracted electrode is appropriately cut, immersed in a solvent, and subjected to ultrasonic waves. As the solvent, an organic solvent such as alcohol or NMP is preferably used. As a result, an active material-containing layer can be peeled off from a current collecting foil. Next, a dispersion obtained by dispersing the peeled active material-containing layer in a solvent is subjected to centrifugal separation. As a result, the active material can be separated from a powder of the active material-containing layer including an electro-conductive agent such as carbon.

### (Identification of First Particle)

The inclusion of particles including niobium titanium oxide in the separated active material can be identified by inductively coupled plasma (ICP) emission spectroscopy. ICP analysis can be specifically performed as follows. The active material separated by the above-described method is dissolved in an acid to prepare a measurement sample. The prepared measurement sample is analyzed by the ICP emission spectroscopy, and a concentration of each element per unit weight in the measurement sample is measured. Examples of an ICP analytical device can include SPS-3520UV manufactured by SII NanoTechnology Inc., or an apparatus having a function equivalent thereto. From this measurement result, a composition ratio among the metal elements included in the active material can be calculated. From this composition ratio, the inclusion of particles including niobium titanium oxide in the active material can be identified.

Further inclusion of an inorganic particle-containing layer in the particles including niobium titanium oxide can be identified as follows. The active material separated by the above-described method is observed with a transmission electron microscope (TEM), and element mapping is performed by energy dispersive X-ray spectroscopy (EDX) measurement, whereby particles further including an inorganic particle-containing layer can be discriminated among the particles including niobium titanium oxide.

Among the particles including niobium titanium oxide, the particles further including the inorganic particle-containing layer can be identified as the first particles.

### (Discrimination Between Niobium Titanium Oxide Particle and Inorganic Particle-Containing Layer)

The niobium titanium oxide particles and the inorganic particle-containing layer can be discriminated by observing the first particles in the active material with a transmission electron microscope (TEM).

For the TEM observation, a high-angle annular dark field scanning transmission electron microscope (HAADF-STEM) image is preferably used. HAADF-STEM is a technique of detecting and observing transmitted electrons scattered to a high angle side, and can provide a contrast proportional to an atomic weight. In the first particles, the niobium titanium oxide particles including niobium titanium composite oxide may include more Nb elements than in the inorganic particle-containing layer. Therefore, in the HAADF-STEM image of the first particles, the niobium titanium oxide particles can be observed dark relative to the inorganic particle-containing layer. Thus, the inorganic particle-containing layer and the niobium titanium oxide particles can be clearly discriminated from each other based on a difference in contrast.

### (Method for Measuring Thickness of Inorganic Particle-Containing Layer)

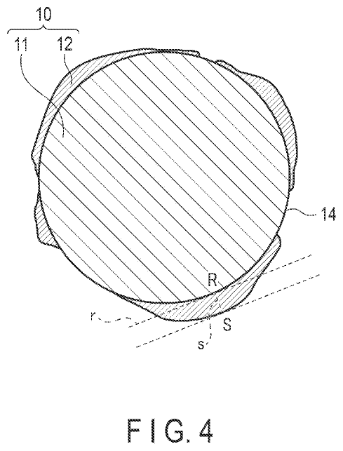

A method for measuring the thickness of the inorganic particle-containing layer will be described with reference to FIG. 4. FIG. 4 is a view schematically illustrating a HAADF-STEM image of a first particle.

First, an arbitrary first particle 10 is selected from the TEM observation image. Next, HAADF-STEM observation is performed on the selected first particle 10. In the obtained HAADF-STEM image, a niobium titanium oxide particle 11 and an inorganic particle-containing layer 12 can be discriminated from each other based on the contrast.

In the HAADF-STEM image of the first particle 10, one point on the surface of the niobium titanium oxide particle 11 is set as a point R. The point R may be in the innermost part of the inorganic particle-containing layer 12. Next, a tangent r of the point R in the niobium titanium oxide particle 11 is drawn. A line s perpendicular to the tangent r of the point R is drawn. A point at which the line s intersects the outermost part of the first particle 10 is defined as a point S. The point S may be in the outermost part of the inorganic particle-containing layer 12. The same operation is performed on the same first particle 10, and a largest distance RS in the first particle 10 is defined as the thickness of the inorganic particle-containing layer 12 of the first particle. The same operation is performed on 10 first particles, and an average value therefor is defined as the thickness of the inorganic particle-containing layer 12.

On the surface of the niobium titanium oxide particle 11, a portion where the inorganic particle-containing layer 12 is not formed may be an exposed portion 14.

### (Fe-Tem)

The inclusion of the exposed portion in the first particle can be determined by field-emission transmission electron microscope (FE-TEM) observation of the first particle.

The surface of the first particle is observed with FE-TEM at a high magnification of about 1 million times. In the first particle, a portion without any compound having another composition on the surface of the niobium titanium oxide particle can be defined as the exposed portion.

### <Measurement of Average Particle Size of Inorganic Particle>

The average particle size of the inorganic particles can be measured by TEM observation of a cross section of the electrode.

In a case where an electrode incorporated in a battery is measured, the electrode is extracted from the battery and subjected to measurement in the same manner as described above.

The cross section of the electrode is observed with TEM at a magnification of 1500 times. Among the particles in an observation field, the particles including the element contained in the solid electrolyte described above can be identified as the solid electrolyte-containing particles. For example, in a case where the particles include Al, Ti, and P, the inclusion of a LATP compound which is a lithium phosphate solid electrolyte in the particles can be identified. Among the particles in the observation field, the particles including the element contained in the metal oxide described above can be identified as the particles including the metal oxide. For example, particles including Al can be identified as Al₂O₃-containing particles, particles including Si can be identified as SiO₂-containing particles, particles including Ti can be identified as TiO₂-containing particles, particles including Zr can be identified as ZrO₂-containing particles, and particles including Mg can be identified as MgO-containing particles. Further, by identifying that metal elements other than the metal elements contained in the metal oxide described above are not included in the TEM-EDX measurement, the type of the metal oxide contained in the particles to be measured can be determined. For example, if the particles to be measured do not include a metal element other than Ti, the inclusion of TiO₂ in the particles can be identified. The solid electrolyte-containing particles and the particles including the metal oxide can be identified as the inorganic particles. The particle sizes of the five inorganic particles in the observation field are measured, and an average value thereof is defined as the average particle size.

The electrode according to the first embodiment includes: inorganic particles; niobium titanium oxide particles; and an inorganic particle-containing layer covering at least a part of surfaces of the niobium titanium oxide particles. An average particle size of the inorganic particles is larger than a thickness of the inorganic particle-containing layer. Therefore, the electrode can have improved cycle performance and output performance.

### Second Embodiment

According to a second embodiment, there is provided a secondary battery including a negative electrode, a positive electrode, and an electrolyte. At least one of the positive electrode and the negative electrode is the electrode according to the first embodiment. That is, the secondary battery includes the electrode according to the first embodiment.

The secondary battery may further include a separator provided between the positive electrode and the negative electrode. The negative electrode, the positive electrode, and the separator may configure an electrode group. The electrolyte may be held in the electrode group.

The secondary battery may further include a container member that houses the electrode group and the electrolyte.

The secondary battery may further include a negative electrode terminal electrically connected to the negative electrode and a positive electrode terminal electrically connected to the positive electrode.

The secondary battery may be, for example, a lithium secondary battery. The secondary battery also includes nonaqueous electrolyte secondary batteries including nonaqueous electrolyte (s).

Hereinafter, the negative electrode, positive electrode, electrolyte, separator, container member, negative electrode terminal, and positive electrode terminal will be described in detail.

### 1) Negative Electrode

The negative electrode may include a negative electrode current collector and a negative electrode active material-containing layer. The negative electrode current collector and the negative electrode active material-containing layer may respectively be the current collector and the active material-containing layer that can be included in the electrode according to the first embodiment. The negative electrode active material-containing layer may include first particles including niobium titanium oxide particles and an inorganic particle-containing layer as a negative electrode active material.

Of the details of the negative electrode, portions that overlap with the details described in the first embodiment are omitted.

A density of the negative electrode active material-containing layer (excluding the current collector) is preferably from 1.8 g/cm³ or more and 2.8 g/cm³ or less. A negative electrode including the negative electrode active material-containing layer having a density within this range is excellent in energy density and electrolyte retention. The density of the negative electrode active material-containing layer is more preferably 2.1 g/cm³ or more and 2.6 g/cm³ or less.

The negative electrode may be fabricated, for example, by the same method as that for the electrode according to the first embodiment.

### 2) Positive Electrode

The positive electrode may include a positive electrode current collector and a positive electrode active material-containing layer. The positive electrode active material-containing layer may be formed on one side or both sides of the positive electrode current collector. The positive electrode active material-containing layer may include a positive electrode active material, and optionally an electro-conductive agent and a binder.

As the positive electrode active material, for example, an oxide or a sulfide may be used. The positive electrode may include one type of compound singly as the positive electrode active material, or, alternatively, may include two or more types of compounds in combination. Examples of the oxide and sulfide include compounds capable of having Li and Li ions be inserted and extracted.

Examples of such compounds include manganese dioxide (MnO₂), iron oxides, copper oxides, nickel oxides, lithium manganese composite oxides (e.g., LiₓMn₂O₄ or LiₓMnO₂; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0<y<1), lithium manganese cobalt composite oxides (e.g., LiₓMn_{y}Co_{1-y}O₂; 0<x≤1, 0<y<1), lithium manganese nickel composite oxides having a spinel structure (e.g., LiₓMn_{2-y}Ni_{y}O₄; 0<x≤1, 0<y<2), lithium phosphorus oxides having an olivine structure (e.g., LiₓFePO₄; 0<x≤1, LiₓFe_{1-y}Mn_{y}PO₄; 0<x≤1, 0<y≤1, and LiₓCoPO₄; 0<x≤1), iron sulfate (Fe₂(SO₄)₃), vanadium oxides (e.g., V₂O₅), and lithium nickel cobalt manganese composite oxide (LiₓNi_{1-y-z}Co_{y}Mn_{z}O₂; 0<x≤1, 0<y<1, 0<z<1, y+z<1).

Among the above, examples of compounds more preferable as the positive electrode active material include lithium manganese composite oxides having a spinel structure (e.g., LiₓMn₂O₄; 0<x≤1), lithium nickel composite oxides (e.g., LiₓNiO₂; 0<x≤1), lithium cobalt composite oxides (e.g., LiₓCoO₂; 0<x≤1), lithium nickel cobalt composite oxides (e.g., LiₓNi_{1-y}Co_{y}O₂; 0<x≤1, 0<y<1), lithium manganese nickel composite oxides having a spinel structure (e.g., LiₓMn_{2-y}Ni_{y}O₄; 0<x≤1, 0<y<2), lithium manganese cobalt composite oxide (e.g., LiₓMn_{y}Co_{1-y}O₂; 0<x≤1, 0<y<1), lithium iron phosphates (e.g., LiₓFePO₄; 0<x≤1), and lithium nickel cobalt manganese composite oxides (LiₓNi_{1-y-z}Co_{y}Mn_{z}O₂; 0<x≤1, 0<y<1, 0<z<1, y+z<1). The positive electrode potential can be made high by using these compounds as the positive electrode active material.

In a case where an ambient temperature molten salt is used as the electrolyte of the battery, it is preferable to use a positive electrode active material including lithium iron phosphate, LiₓVPO₄F (0≤x≤1), lithium manganese composite oxide, lithium nickel composite oxide, lithium nickel cobalt composite oxide, or a mixture thereof. Since these compounds have low reactivity with ambient temperature molten salts, cycle life can be improved. Details of the ambient temperature molten salt will be described later.

A primary particle size of the positive electrode active material is preferably 100 nm or more and 1 μm or less. A positive electrode active material having a primary particle size of 100 nm or more is easy to handle during industrial production. In a positive electrode active material having a primary particle size of 1 μm or less, in-solid diffusion of lithium ions can proceed smoothly.

A specific surface area of the positive electrode active material is preferably 0.1 m²/g or more and 10 m²/g or less. A positive electrode active material having a specific surface area of 0.1 m²/g or more can sufficiently secure sites for inserting and extracting Li ions. A positive electrode active material having a specific surface area of 10 m²/g or less is easy to handle during industrial production, and can secure a good charge-discharge cycle performance.

The binder is blended to fill gaps among the dispersed positive electrode active material and also to bind the positive electrode active material with the positive electrode current collector. Examples of the binder include polytetrafluoro ethylene (PTFE), polyvinylidene fluoride (PVdF), fluororubber, polyacrylic acid compounds, imide compounds, carboxymethyl cellulose (CMC), and salts of CMC. One of these may be used as the binder, or alternatively, two or more may be used in combination as the binder.

The electro-conductive agent is blended to improve current collection performance and to suppress contact resistance between the positive electrode active material and the positive electrode current collector. Examples of the electro-conductive agent include carbonaceous substances such as vapor grown carbon fiber (VGCF), carbon black such as acetylene black, and graphite. One of these may be used as the electro-conductive agent, or two or more may be used in combination as the electro-conductive agent. The electro-conductive agent may not be used.

In the positive electrode active material-containing layer, the positive electrode active material and the binder are preferably blended in proportions of 80 mass % or more and 98 mass % or less, and 2 mass % or more and 20 mass % or less, respectively.

Due to the amount of the binder of 2 mass % or more, sufficient electrode strength can be achieved. The binder may function as an electrical insulator. Thus, in a case where the amount of the binder is 20 mass % or less, the amount of electrical insulator in the electrode is reduced, and thus internal resistance can be decreased.

In a case where the electro-conductive agent is added, the positive electrode active material, the binder, and the electro-conductive agent are preferably blended in proportions of 77 mass % or more and 95 mass % or less, 2 mass % or more and 20 mass % or less, and 3 mass % or more and 15 mass % or less, respectively.

Due to the amount of the electro-conductive agent of 3 mass % or more, the above-described effects can be exhibited. Due to the amount of the electro-conductive agent of 15 mass % or less, the proportion of electro-conductive agent to be contacted with the electrolyte can be reduced. In a case where this proportion is low, decomposition of the electrolyte can be reduced during storage at high temperatures.

The positive electrode current collector is preferably an aluminum foil, or an aluminum alloy foil including one or more selected from the group consisting of Mg, Ti, Zn, Ni, Cr, Mn, Fe, Cu, and Si.

A thickness of the aluminum foil or aluminum alloy foil is preferably 5 μm or more and 20 μm or less, and more preferably 15 μm or less. A purity of the aluminum foil is preferably 99 mass % or more. Contents of transition metals such as iron, copper, nickel, and chromium included in the aluminum foil or aluminum alloy foil are preferably 1 mass % or less.

The positive electrode current collector may include a portion where the positive electrode active material-containing layer is not formed, on a surface thereof. This portion can serve as a positive electrode current-collecting tab.

The positive electrode can be fabricated, for example, by the following method. First, a positive electrode active material, an electro-conductive agent, and a binder are suspended in a solvent to prepare a slurry. The slurry is applied onto one side or both sides of a current collector. Then, the applied slurry is dried to obtain a stack of an active material-containing layer and the current collector. Then, the stack is subjected to pressing. The electrode is fabricated in this manner.

Alternatively, the electrode may be fabricated by the following method. First, an active material including the first particles, inorganic particles, an electro-conductive agent, and a binder are mixed to obtain a mixture. Next, the mixture is formed into pellets. Then, the electrode can be obtained by disposing the pellets onto the current collector.

The positive electrode may also be fabricated, for example, by the same method as that for the electrode according to the first embodiment. In a case where the positive electrode is the electrode according to the first embodiment, the niobium titanium oxide included in the first particles can function as the positive electrode active material. The negative electrode combined with the positive electrode may not be the electrode according to the first embodiment. For example, it can be combined with the inorganic particle-containing layer described in the first embodiment or a negative electrode not including inorganic particles.

### 3) Electrolyte

As the electrolyte, for example, a nonaqueous electrolyte can be used. As the nonaqueous electrolyte, for example, a liquid nonaqueous electrolyte, a gel nonaqueous electrolyte, or a polymeric solid electrolyte can be used. The liquid nonaqueous electrolyte is prepared by dissolving an electrolyte salt as a solute in an organic solvent. The gel nonaqueous electrolyte is prepared by obtaining a composite of a liquid nonaqueous electrolyte and a polymeric material. The polymeric solid electrolyte is prepared by dissolving an electrolyte salt in a polymeric material, and solidifying it. The type of the nonaqueous electrolyte can be one or two or more.

A concentration of the electrolyte salt is preferably 0.5 mol/L or more and 2.5 mol/L or less.

The nonaqueous electrolyte may include a fluorine atom. Examples of the nonaqueous electrolyte containing a fluorine atom include a nonaqueous electrolyte containing an electrolyte salt containing a fluorine atom.

Examples of the electrolyte salt that may be included in the nonaqueous electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide (LiN(CF₃SO₂)₂), and mixtures thereof. The electrolyte salt is preferably hard to oxidize even at a high potential, and is most preferably LiPF₆. Among the above ones, examples of the electrolyte salt containing a fluorine atom include lithium hexafluorophosphate (LiPF₆), lithium tetrafluoroborate (LiBF₄), lithium hexafluoroarsenate (LiAsF₆), lithium trifluoromethanesulfonate (LiCF₃SO₃), and lithium bistrifluoromethylsulfonylimide (LiN(CF₃SO₂)₂). The type of the electrolyte salt can be one or two or more.

Examples of the organic solvent include cyclic carbonates such as propylene carbonate (PC), ethylene carbonate (EC), and vinylene carbonate (VC); linear carbonates such as diethyl carbonate (DEC), dimethyl carbonate (DMC), and methyl ethyl carbonate (MEC); cyclic ethers such as tetrahydrofuran (THF), 2-methyl tetrahydrofuran (2-MeTHF), and dioxolane (DOX); linear ethers such as dimethoxy ethane (DME) and diethoxy ethane (DEE); γ-butyrolactone (GBL), acetonitrile (AN), and sulfolane (SL). These organic solvents may be used singly or as a mixed solvent.

Examples of the polymeric material that is included in the gel nonaqueous electrolyte include polyvinylidene fluoride (PVdF), polyacrylonitrile (PAN), polyethylene oxide (PEO), and mixtures thereof.

Alternatively, other than the liquid nonaqueous electrolyte, gel nonaqueous electrolyte and polymeric solid electrolyte, an ambient temperature molten salt (ionic melt) containing lithium ions, inorganic solid electrolyte, or the like may be used as the nonaqueous electrolyte. The nonaqueous electrolyte may include one of the above-described nonaqueous electrolytes singly or two or more thereof. Among the nonaqueous electrolytes described above, the ambient temperature molten salt or the inorganic solid electrolyte may be mixed with a liquid nonaqueous electrolyte, a gel nonaqueous electrolyte, or a polymeric solid electrolyte for use.

The ambient temperature molten salt (ionic melt) refers to a compound among organic salts made of combinations of organic cations and anions, which is able to exist in a liquid state at an ambient temperature (15° C. or higher and 25° C. or lower). The ambient temperature molten salt includes an ambient temperature molten salt which exists alone as a liquid, an ambient temperature molten salt which becomes a liquid upon mixing with an electrolyte salt, an ambient temperature molten salt which becomes a liquid upon dissolution in an organic solvent, and mixtures thereof. In general, a melting point of the ambient temperature molten salt used in a secondary battery is 25° C. or lower. The organic cations generally have a quaternary ammonium skeleton.

The inorganic solid electrolyte is a solid substance having Li ion conductivity. Having Li ion conductivity, as referred to herein, indicates exhibiting a lithium ion conductivity of 1×10⁻⁶ S/cm or more at 25° C. Examples of the inorganic solid electrolyte include oxide solid electrolytes and sulfide solid electrolytes. Specific examples of the inorganic solid electrolyte will be described below.

Preferably used as the oxide solid electrolyte is a lithium phosphate solid electrolyte having a sodium (Na) super ionic conductor (NASICON) structure and represented by a general formula Li₁₊ₓMα₂(PO₄)₃. Mα in the above general formula is, for example, one or more selected from the group consisting of titanium (Ti), germanium (Ge), strontium (Sr), zirconium (Zr), tin (Sn), aluminum (Al), and calcium (Ca). The subscript x is in a range of 0≤x≤2.

Specific examples of the lithium phosphate solid electrolyte having the NASICON structure include a LATP compound represented by Li₁₊ₓAlₓTi₂₋ₓ(PO₄)₃ where 0.1≤x≤0.5; a compound represented by Li₁₊ₓAl_{y}Mβ_{2-y}(PO₄)₃ where Mβ is one or more selected from the group consisting of Ti, Ge, Sr, Zr, Sn, and Ca, 0≤x≤1, and 0≤y≤1; a compound represented by Li₁₊ₓAlₓGe₂₋ₓ(PO₄)₃ where 0≤x≤2; a compound represented by Li₁₊ₓAlₓZr₂₋ₓ(PO₄)₃ where 0≤x≤2; a compound represented by Li_{1+x+y}AlₓMγ₂₋ₓSi_{y}P_{3-y}O₁₂ where Mγ is one or more selected from the group consisting of Ti and Ge, 0<x≤2, and 0≤y<3; and a compound represented by Li₁₊₂ₓZr₁₋ₓCaₓ(PO₄)₃ where 0≤x≤1.

In addition to the above lithium phosphate solid electrolyte, examples of the oxide solid electrolyte include amorphous LIPON compounds represented by LiₓPO_{y}N_{z} where 2.6≤x≤3.5, 1.9≤y≤3.8, and 0.1≤z≤1.3 (e.g., Li_{2.9}PO_{3.3}N_{0.46}); a compound having a garnet structure represented by La₅₊ₓAₓLa₃₋ₓMδ₂O₁₂ where A is one or more selected from the group consisting of Ca, Sr, and Ba, Mδ is one or more selected from the group consisting of Nb and Ta, and 0≤x≤0.5; a compound represented by Li₃Mδ₂₋ₓL₂O₁₂ where Mδ is one or more selected from the group consisting of Nb and Ta, L may include Zr, and 0≤x≤0.5; a compound represented by Li₇₋₃ₓAlₓLa₃Zr₃O₁₂ where 0≤x≤0.5; a LLZ compound represented by Li₅₊ₓLa₃Mδ₂₋ₓZrₓO₁₂ where Mδ is one or more selected from the group consisting of Nb and Ta, and 0≤x≤2 (e.g., Li₇La₃Zr₂O₁₂); and a compound having a perovskite structure and represented by La_{2/3-x}LiₓTiO₃ where 0.3≤x≤0.7.

One or more among the above compounds may be used as the solid electrolyte. Two or more of the above solid electrolytes may be used.

### 4) Separator

The separator may be made of, for example, a porous film or synthetic resin nonwoven fabric including polyethylene (PE), polypropylene (PP), cellulose, or polyvinylidene fluoride (PVdF). In view of safety, a porous film made of polyethylene or polypropylene is preferred. This is because, at a certain temperature, such a porous film melts and can shut off current.

### 5) Container Member

As the container member, for example, a container made of a laminate film or a container made of a metal may be used.

A thickness of the laminate film is, for example, 0.5 mm or less, and preferably 0.2 mm or less.

As the laminate film, used is a multilayer film including a plurality of resin layers and a metal layer sandwiched between the respective resin layers. The resin layer may include, for example, a polymeric material such as polypropylene (PP), polyethylene (PE), nylon, or polyethylene terephthalate (PET). The metal layer is preferably made of an aluminum foil or an aluminum alloy foil, in order to reduce weight. The laminate film may be formed into the shape of the container member, by heat-sealing.

A wall thickness of the metal container is, for example, 1 mm or less, more preferably 0.5 mm or less, and further preferably 0.2 mm or less.

The metal container is made, for example, of aluminum or an aluminum alloy. The aluminum alloy preferably includes elements such as magnesium, zinc, and silicon. In a case where the aluminum alloy includes a transition metal such as iron, copper, nickel, or chromium, a content thereof is preferably 100 ppm by mass or less.

The shape of the container member is not particularly limited. The shape of the container member may be, for example, flat (thin), prismatic, cylindrical, coin-shaped, or button-shaped. The container member may be appropriately selected depending on the battery dimensions and the use of the battery.

### 6) Negative Electrode Terminal

The negative electrode terminal may be formed of a material that is electrically stable in a potential range of 1 V or more and 3 V or less (vs. Li/Li⁺) relative to an oxidation-reduction potential of lithium, and having electrical conductivity. Specific examples of the material for the negative electrode terminal include copper, nickel, stainless steel, and aluminum, and aluminum alloys including at least one selected from the group consisting of Mg, Ti, Zn, Mn, Fe, Cu, and Si. Aluminum or an aluminum alloy is preferably used as the material for the negative electrode terminal. The negative electrode terminal is preferably made of the same material as the negative electrode current collector, in order to reduce contact resistance between the negative electrode terminal and the negative electrode current collector.

### 7) Positive Electrode Terminal

The positive electrode terminal can be formed of a material that is electrically stable in a potential range of 3 V or more and 4.5 V or less (vs. Li/Li⁺) relative to the oxidation-reduction potential of lithium, and having electrical conductivity. Examples of the material for the positive electrode terminal include aluminum and aluminum alloys including at least one selected from the group consisting of Mg, Ti, Zn, Mn, Fe, Cu, and Si. The positive electrode terminal is preferably formed of the same material as the positive electrode current collector, in order to reduce contact resistance between the positive electrode terminal and the positive electrode current collector.

Next, the secondary battery according to the embodiment will be more specifically described with reference to the drawings.

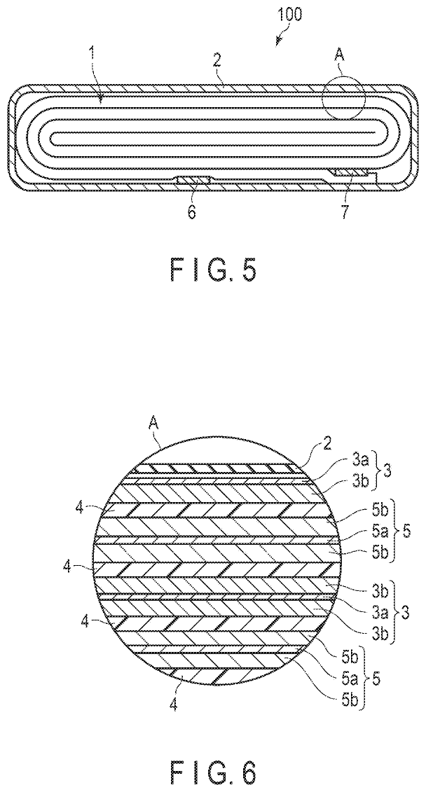

FIG. 5 is a cross-sectional view schematically illustrating an example of the secondary battery. FIG. 6 is an enlarged cross-sectional view of a section A of the secondary battery illustrated in FIG. 5.

A secondary battery 100 as illustrated in FIGS. 5 and 6 includes a bag-shaped container member 2 as illustrated in FIG. 5, an electrode group 1 as illustrated in FIGS. 5 and 6, and an electrolyte which is not illustrated. The electrode group 1 and the electrolyte are housed in the bag-shaped container member 2. The electrolyte (not illustrated) is held in the electrode group 1.

The bag-shaped container member 2 is made of a laminate film including two resin layers and a metal layer sandwiched between the resin layers.

As illustrated in FIG. 5, the electrode group 1 is a wound electrode group in a flat form. The wound electrode group 1 in a flat form includes a negative electrode 3, a separator 4, and a positive electrode 5, as illustrated in FIG. 6. The separator 4 is sandwiched between the negative electrode 3 and the positive electrode 5.

The negative electrode 3 includes a negative electrode current collector 3a and a negative electrode active material-containing layer 3b. At a portion of the negative electrode 3 positioned outermost among the wound electrode group 1, the negative electrode active material-containing layer 3b is formed only on an inner surface of the negative electrode current collector 3a, as illustrated in FIG. 6. For the other portions of the negative electrode 3, the negative electrode active material-containing layers 3b are formed on both sides of the negative electrode current collector 3a.

The positive electrode 5 includes a positive electrode current collector 5a and positive electrode active material-containing layers 5b formed on both sides of the positive electrode current collector 5a.

As illustrated in FIG. 5, a negative electrode terminal 6 and a positive electrode terminal 7 are positioned in vicinity of an outer peripheral end of the wound electrode group 1. The negative electrode terminal 6 is connected to a portion of the negative electrode current collector 3a positioned outermost. The positive electrode terminal 7 is connected to a portion of the positive electrode current collector 5a positioned outermost. The negative electrode terminal 6 and the positive electrode terminal 7 extend outside from an opening of the bag-shaped container member 2. A thermoplastic resin layer is provided on an inner surface of the bag-shaped container member 2, and the opening is closed by heat-sealing the resin layer.

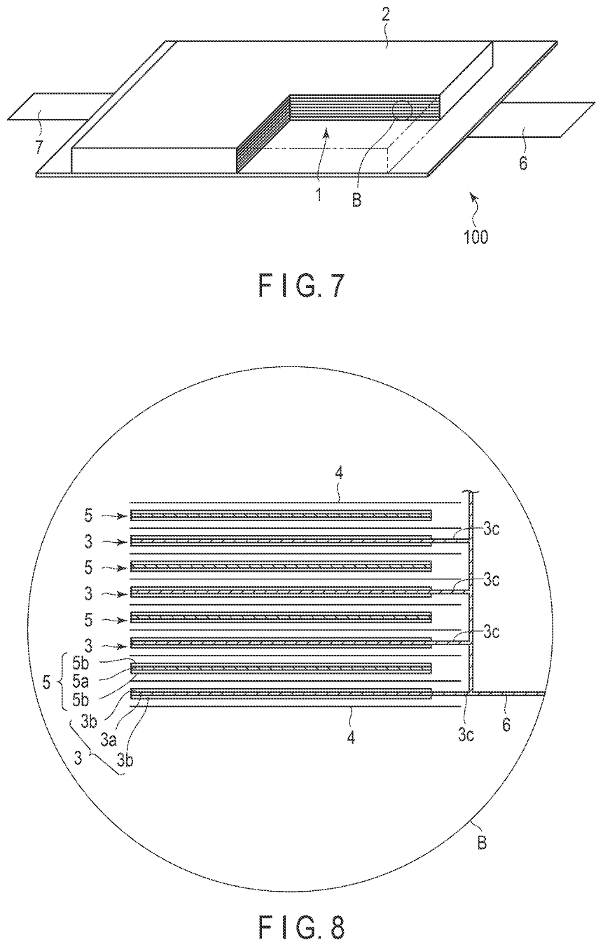

The secondary battery according to the embodiment is not limited to the secondary battery having the structure illustrated in FIGS. 5 and 6, and may be, for example, a battery having a structure as illustrated in FIGS. 7 and 8.

FIG. 7 is a partially cut-out perspective view schematically illustrating another example of the secondary battery. FIG. 8 is an enlarged cross-sectional view of a section B of the secondary battery illustrated in FIG. 7.

A secondary battery 100 as illustrated in FIGS. 7 and 8 includes an electrode group 1 as illustrated in FIGS. 7 and 8, a container member 2 as illustrated in FIG. 7, and an electrolyte which is not illustrated. The electrode group 1 and the electrolyte are housed in the container member 2. The electrolyte is held in the electrode group 1.

The container member 2 is made of a laminate film including two resin layers and a metal layer sandwiched between the resin layers.

As illustrated in FIG. 8, the electrode group 1 is a stacked electrode group. The stacked electrode group 1 has a structure in which negative electrodes 3 and positive electrodes 5 are alternately stacked with separators 4 sandwiched therebetween.

The electrode group 1 includes a plurality of the negative electrodes 3. Each of the negative electrodes 3 includes a negative electrode current collector 3a and negative electrode active material-containing layers 3b supported on both sides of the negative electrode current collector 3a. The electrode group 1 further includes a plurality of the positive electrodes 5. Each of the positive electrodes 5 includes a positive electrode current collector 5a and positive electrode active material-containing layers 5b supported on both sides of the positive electrode current collector 5a.

The negative electrode current collector 3a of each of the negative electrodes 3 includes, at one end, a portion where the negative electrode active material-containing layer 3b is not supported on either surface. This portion serves as a negative electrode current-collecting tab 3c. As shown in FIG. 8, the negative electrode current-collecting tabs 3c do not overlap the positive electrodes 5. A plurality of the negative electrode current-collecting tabs 3c are electrically connected to a strip-shaped negative electrode terminal 6. A tip of the strip-shaped negative electrode terminal 6 is drawn outside from the container member 2.

Although not illustrated, the positive electrode current collector 5a of each of the positive electrodes 5 includes, at one end, a portion where the positive electrode active material-containing layer 5b is not supported on either surface. This portion serves as a positive electrode current-collecting tab. The positive electrode current-collecting tabs do not overlap the negative electrodes 3 in the same manner as the negative electrode current-collecting tabs 3c do not overlap the positive electrodes 5. Further, the positive electrode current-collecting tabs are located on an opposite side of the electrode group 1 relative to the negative electrode current-collecting tabs 3c. The positive electrode current-collecting tabs are electrically connected to a strip-shaped positive electrode terminal 7. A tip of the strip-shaped positive electrode terminal 7 is located on an opposite side relative to the negative electrode terminal 6 and drawn outside from the container member 2.

The secondary battery according to the second embodiment includes the electrode according to the first embodiment. Therefore, according to the embodiment, it is possible to provide a secondary battery having improved cycle performance and output performance.

### Third Embodiment

According to a third embodiment, a battery module is provided. The battery module includes a plurality of the secondary batteries according to the second embodiment.

In the battery module, each of single-batteries may be disposed to be electrically connected in series or in parallel, or may be disposed in a combination of series connection and parallel connection.

Next, an example of the battery module according to the embodiment will be described, with reference to the drawings.

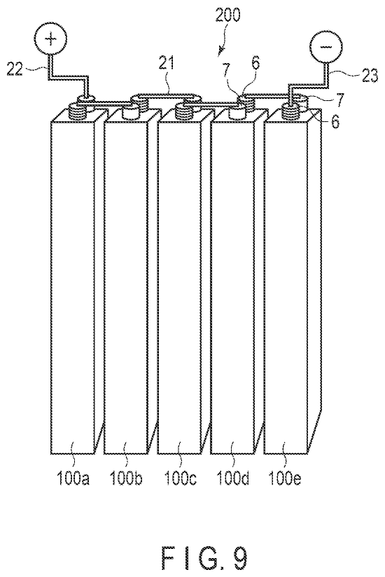

FIG. 9 is a perspective view schematically illustrating an example of the battery module. A battery module 200 illustrated in FIG. 9 includes five single-batteries 100a to 100e, four bus bars 21, a positive electrode-side lead 22, and a negative electrode-side lead 23. Each of the five single-batteries 100a to 100e is the secondary battery according to the second embodiment.

The bus bar 21 connects, for example, a negative electrode terminal 6 of the one single-battery 100a and a positive electrode terminal 7 of the single-battery 100b positioned adjacent thereto. In such a manner, the five single-batteries 100 are thus connected in series by the four bus bars 21. That is, the battery module 200 illustrated in FIG. 9 is a battery module in which five single-batteries are connected in series. Although no example is illustrated, in a battery module including a plurality of single-batteries that are electrically connected in parallel, for example, the single-batteries may be electrically connected by having a plurality of negative electrode terminals connected to each other by bus bars and also having a plurality of positive electrode terminals connected to each other by bus bars.

The positive electrode terminal 7 of at least one battery among the five single-batteries 100a to 100e is electrically connected to the positive electrode-side lead 22 for external connection. In addition, the negative electrode terminal 6 of at least one battery among the five single-batteries 100a to 100e is electrically connected to the negative electrode-side lead 23 for external connection.

The battery module according to the third embodiment includes the secondary battery according to the second embodiment. This contributes to achievement of excellent cycle performance and output performance.

### Fourth Embodiment

According to a fourth embodiment, a battery pack is provided. The battery pack includes the battery module according to the third embodiment. The battery pack may include a single secondary battery according to the second embodiment, in place of the battery module according to the third embodiment.

The battery pack may further include a protective circuit. The protective circuit has a function to control charge and discharge of the secondary battery. Alternatively, a circuit included in an apparatus where the battery pack is used as a power source (for example, an electronic device or an automobile) may be used as the protective circuit for the battery pack.

Moreover, the battery pack may further include an external power distribution terminal. The external power distribution terminal is configured to externally output current from the secondary battery, and/or to input external current into the secondary battery. In other words, in a case where the battery pack is used as a power source, the current is supplied outside via the external power distribution terminal. When the battery pack is charged, charge current (including regenerative energy of motive force of a vehicle such as an automobile) is supplied to the battery pack via the external power distribution terminal.

Next, an example of the battery pack according to the embodiment will be described, with reference to the drawings.

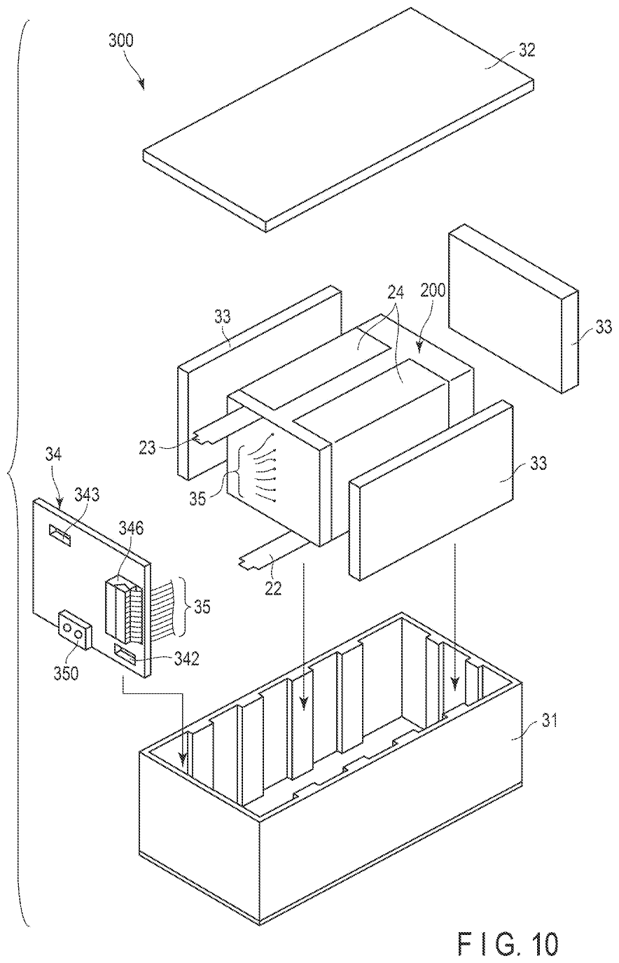

FIG. 10 is an exploded perspective view schematically illustrating an example of the battery pack. FIG. 11 is a block diagram illustrating an example of an electric circuit of the battery pack illustrated in FIG. 10.

A battery pack 300 as illustrated in FIGS. 10 and 11 includes a housing container 31, a lid 32, protective sheets 33, a battery module 200, a printed wiring board 34, wirings 35, and an insulating plate (not illustrated).

The housing container 31 illustrated in FIG. 10 is a prismatic bottomed container having a rectangular bottom surface. The housing container 31 is configured to be capable of housing the protective sheets 33, the battery module 200, the printed wiring board 34, and the wirings 35. The lid 32 has a rectangular shape. The lid 32 covers the housing container 31 to house the battery module 200 and the like. Although not illustrated, the housing container 31 and the lid 32 are provided with openings, connection terminals, or the like for connection to an external device or the like.

The battery module 200 includes a plurality of single-batteries 100, a positive electrode-side lead 22, a negative electrode-side lead 23, and adhesive tapes 24.

At least one of the single-batteries 100 is the secondary battery according to the second embodiment. The single-batteries 100 are electrically connected in series, as illustrated in FIG. 11. The single-batteries 100 may be electrically connected in parallel, or connected in a combination of in series and in parallel. If the single-batteries 100 are connected in parallel, battery capacity increases as compared to a case in which they are connected in series.

The adhesive tapes 24 fasten the single-batteries 100. Instead of the adhesive tape 24, a heat-shrinkable tape may be used to fix the single-batteries 100. In this case, the protective sheets 33 are disposed on both side surfaces of the battery module 200, and the heat shrinkable tape is wound around the battery module 200 and protective sheets 33. After that, the heat shrinkable tape is shrunk by heating to bundle the single-batteries 100.

One end of the positive electrode-side lead 22 is connected to the battery module 200. The one end of the positive electrode-side lead 22 is electrically connected to positive electrode(s) of one or more of the single-batteries 100. One end of the negative electrode-side lead 23 is connected to the battery module 200. The one end of the negative electrode-side lead 23 is electrically connected to negative electrode(s) of one or more of the single-batteries 100.

The printed wiring board 34 is provided along one face in the short side direction among inner surfaces of the housing container 31. The printed wiring board 34 includes a positive electrode-side connector 342, a negative electrode-side connector 343, a thermistor 345, a protective circuit 346, wirings 342a and 343a, an external power distribution terminal 350, a plus-side wiring (positive-side wiring) 348a, and a minus-side wiring (negative-side wiring) 348b. One principal surface of the printed wiring board 34 faces a side surface of the battery module 200. An insulating plate (not illustrated) is sandwiched between the printed wiring board 34 and the battery module 200.

The other end 22a of the positive electrode-side lead 22 is electrically connected to the positive electrode-side connector 342. The other end 23a of the negative electrode-side lead 23 is electrically connected to the negative electrode-side connector 343.

The thermistor 345 is fixed to one principal surface of the printed wiring board 34. The thermistor 345 detects the temperature of each of the single-batteries 100 and transmits detection signals to the protective circuit 346.

The external power distribution terminal 350 is fixed to the other principal surface of the printed wiring board 34. The external power distribution terminal 350 is electrically connected to a device that exists outside the battery pack 300. The external power distribution terminal 350 includes a positive-side terminal 352 and a negative-side terminal 353.

The protective circuit 346 is fixed to the other principal surface of the printed wiring board 34. The protective circuit 346 is connected to the positive-side terminal 352 via the plus-side wiring 348a. The protective circuit 346 is connected to the negative-side terminal 353 via the minus-side wiring 348b. In addition, the protective circuit 346 is electrically connected to the positive electrode-side connector 342 via the wiring 342a. The protective circuit 346 is electrically connected to the negative electrode-side connector 343 via the wiring 343a. Furthermore, the protective circuit 346 is electrically connected to each of the single-batteries 100 via the wiring 35.

The protective sheets 33 are disposed on both inner side surfaces of the housing container 31 in the long side direction and on the inner side surface in the short side direction facing the printed wiring board 34 across the battery module 200. The protective sheets 33 are made of, for example, resin or rubber.

The protective circuit 346 controls charge and discharge of the single-batteries 100. The protective circuit 346 is also configured to cut-off electric connection between the protective circuit 346 and the external power distribution terminal 350 (positive-side terminal 352, negative-side terminal 353) to an external device, based on detection signals transmitted from the thermistor 345 or detection signals transmitted from each of the single-batteries 100 or the battery module 200.

An example of the detection signal transmitted from the thermistor 345 is a signal indicating that the temperature of the single-battery(s) 100 is detected to be a predetermined temperature or higher. Examples of the detection signal transmitted from each of the single-batteries 100 or the battery module 200 include signals indicating detection of over-charge, over-discharge, and overcurrent of the single-battery(s) 100. In a case where over-charge or the like for each of the single-batteries 100 is detected, the battery voltage may be detected, or a positive electrode potential or negative electrode potential may be detected. In the latter case, a lithium electrode to be used as a reference electrode is inserted into each of the single-batteries 100.

Note that, as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output current from the battery module 200 to an external device and input current from an external device to the battery module 200 via the external power distribution terminal 350. In other words, when the battery pack 300 is used as a power source, the current from the battery module 200 is supplied to an external device via the external power distribution terminal 350. When the battery pack 300 is charged, a charge current from an external device is supplied to the battery pack 300 via the external power distribution terminal 350. If the battery pack 300 is used as an onboard battery, regenerative energy of motive force of a vehicle can be used as the charge current from the external device.

Note that the battery pack 300 may include a plurality of the battery modules 200. In this case, the battery modules 200 may be connected in series, may be connected in parallel, or may be connected in a combination of in series and in parallel. The printed wiring board 34 and the wirings 35 may not be used. In this case, the positive electrode-side lead 22 and the negative electrode-side lead 23 may respectively be used as the positive-side terminal 352 and negative-side terminal 353 of the external power distribution terminal 350.

Such a battery pack is used, for example, in applications where excellent cycle performance is demanded when a large current is extracted. More specifically, the battery pack is used as, for example, a power source for electronic devices, a stationary battery, or an onboard battery for various types of vehicles. An example of the electronic device can be a digital camera. The battery pack is particularly suitably used as the onboard battery.

The battery pack according to the fourth embodiment includes the secondary battery according to the second embodiment or the battery module according to the third embodiment. Therefore, the battery pack can achieve excellent cycle performance and output performance.

### Fifth Embodiment

According to a fifth embodiment, a vehicle is provided. This vehicle is mounted with the battery pack according to the fourth embodiment.

In the vehicle, the battery pack is configured, for example, to recover regenerative energy from motive force of the vehicle. The vehicle may include a mechanism (regenerator) configured to convert kinetic energy of the vehicle into regenerative energy.

Examples of the vehicle include two-wheeled to four-wheeled hybrid electric automobiles, two-wheeled to four-wheeled electric automobiles, electrically assisted bicycles, and railway cars.

The mounting position of the battery pack within the vehicle is not particularly limited. For example, in a case where the battery pack is mounted in an automobile, the battery pack may be mounted in an engine compartment of the vehicle, in a rear part of the vehicle body, or under a seat.

The vehicle may be mounted with a plurality of the battery packs. In this case, batteries included in each of the battery packs may be electrically connected in series, electrically connected in parallel, or electrically connected in a combination of in series and in parallel. For example, when each of the battery packs includes a battery module, the battery modules may be electrically connected in series, may be electrically connected in parallel, or may be electrically connected in a combination of in series and in parallel.

Alternatively, in a case where each of the battery packs includes a single battery, the batteries may be electrically connected in series, electrically connected in parallel, or electrically connected in a combination of in series and in parallel.

Next, an example of the vehicle according to the embodiment will be described, with reference to the drawings.

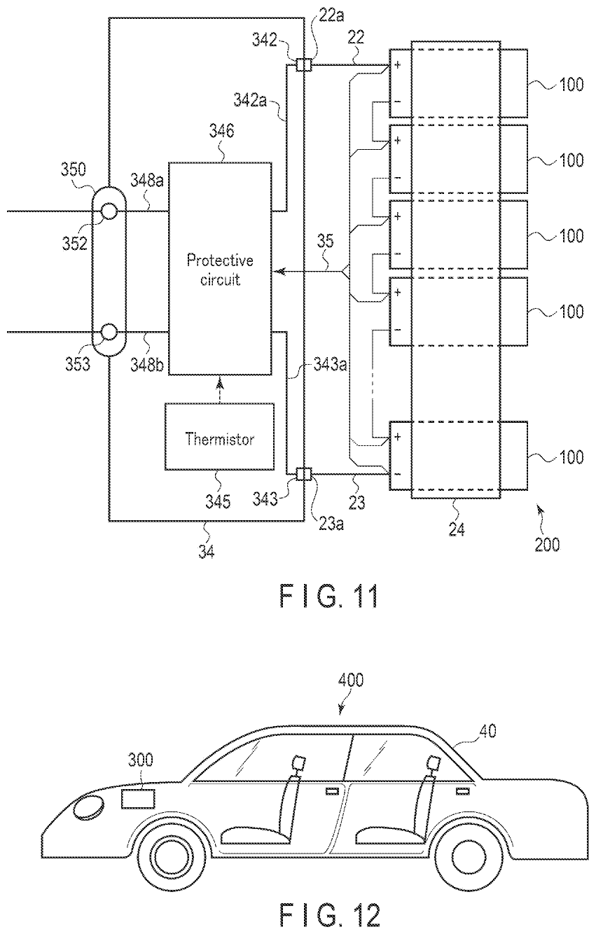

FIG. 12 is a partially see-through diagram schematically illustrating an example of the vehicle.

A vehicle 400 as illustrated in FIG. 12 includes a vehicle body 40 and a battery pack 300 according to the fourth embodiment. In the example illustrated in FIG. 12, the vehicle 400 is a four-wheeled automobile.

This vehicle 400 may have a plurality of battery packs 300 mounted therein. In this case, the batteries (e.g., single-batteries or battery modules) included in the battery packs 300 may be connected in series, connected in parallel, or connected in a combination of in series and in parallel.

In FIG. 12, illustrated is an example where the battery pack 300 is mounted in an engine compartment located at the front of the vehicle body 40. As described above, for example, the battery pack 300 may be alternatively mounted in a rear part of the vehicle body 40, or under a seat. The battery pack 300 may be used as a power source for the vehicle 400. The battery pack 300 can also recover regenerative energy of motive force of the vehicle 400.

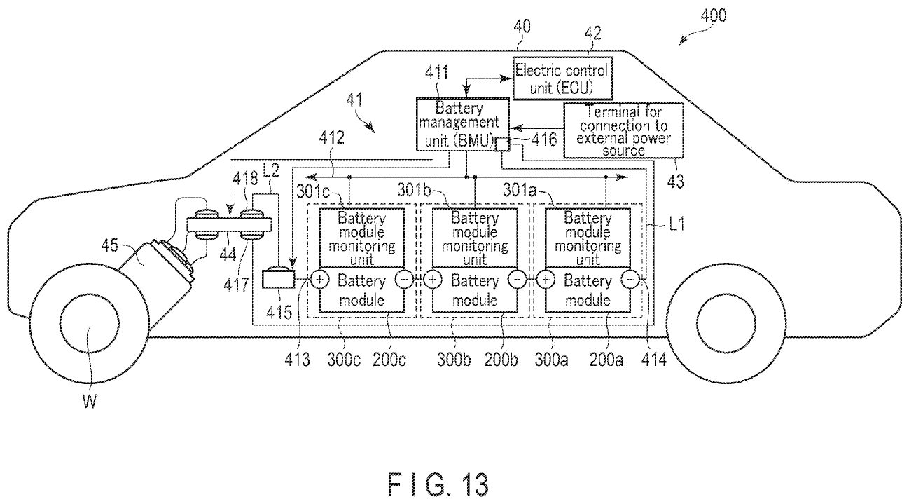

Next, with reference to FIG. 13, an aspect of operation of the vehicle according to the embodiment will be described.

FIG. 13 is a diagram schematically illustrating an example of a control system related to an electric system in the vehicle. A vehicle 400 as illustrated in FIG. 13 is an electric automobile.

The vehicle 400 illustrated in FIG. 13 includes a vehicle body 40, a vehicle power source 41, a vehicle electric control unit (ECU) 42, which is a master controller of the vehicle power source 41, an external terminal (a terminal for connection to an external power source) 43, an inverter 44, and a drive motor 45.

The vehicle 400 includes the vehicle power source 41, for example, in an engine compartment, in a rear part of the vehicle body of the automobile, or under a seat. In FIG. 13, the position of the vehicle power source 41 mounted in the vehicle 400 is schematically illustrated.

The vehicle power source 41 includes a plurality of (for example, three) battery packs 300a, 300b and 300c, a battery management unit (BMU) 411, and a communication bus 412.

The battery pack 300a includes a battery module 200a and a battery module monitoring unit 301a (e.g., a VTM: voltage temperature monitoring). The battery pack 300b includes a battery module 200b and a battery module monitoring unit 301b. The battery pack 300c includes a battery module 200c and a battery module monitoring unit 301c. The battery packs 300a to 300c are battery packs similar to the above-described battery pack 300, and the battery modules 200a to 200c are battery modules similar to the above-described battery module 200. The battery modules 200a to 200c are electrically connected in series. The battery packs 300a, 300b and 300c can each be independently removed, and may be exchanged by a different battery pack 300.

Each of the battery modules 200a to 200c includes a plurality of single-batteries connected in series. At least one of the single-batteries is the secondary battery according to the second embodiment. The battery modules 200a to 200c each perform charge and discharge via a positive electrode terminal 413 and a negative electrode terminal 414.

The battery management unit 411 performs communication with the battery module monitoring units 301a to 301c and collects information on a voltage, a temperature or the like of each of the single-batteries 100 included in the battery modules 200a to 200c included in the vehicle power source 41. In this manner, the battery management unit 411 collects information on security of the vehicle power source 41.

The battery management unit 411 and the battery module monitoring units 301a to 301c are connected via the communication bus 412. In the communication bus 412, a set of communication lines is shared at a plurality of nodes (i.e., the battery management unit 411 and one or more battery module monitoring units 301a to 301c). The communication bus 412 is, for example, a communication bus configured based on CAN (control area network) standard.

The battery module monitoring units 301a to 301c measure a voltage and a temperature of each of the single-batteries in the battery modules 200a to 200c based on commands from the battery management unit 411. It is possible, however, to measure the temperatures only at several points per battery module, and the temperatures of all of the single-batteries need not be measured.

The vehicle power source 41 may also have an electromagnetic contactor (for example, a switch unit 415 shown in FIG. 13) for switching on and off electrical connection between the positive electrode terminal 413 and the negative electrode terminal 414. The switch unit 415 includes a precharge switch (not illustrated), which is turned on when the battery modules 200a to 200c are charged, and a main switch (not illustrated), which is turned on when output from the battery modules 200a to 200c is supplied to a load. The precharge switch and the main switch each include a relay circuit (not illustrated), which is switched on or off based on a signal provided to a coil disposed near the switch elements. The electromagnetic contactor such as the switch unit 415 is controlled based on control signals from the battery management unit 411, or the vehicle ECU 42 which controls the operation of the entire vehicle 400.

The inverter 44 converts an inputted direct current voltage to a three-phase alternate current (AC) high voltage for driving a motor. Three-phase output terminal(s) of the inverter 44 is (are) connected to each three-phase input terminal of the drive motor 45. The inverter 44 is controlled based on control signals from the battery management unit 411, or the vehicle ECU 42 which controls the entire operation of the vehicle. Due to the inverter 44 being controlled, output voltage from the inverter 44 is adjusted.

The drive motor 45 is rotated by electric power supplied from the inverter 44. The drive force generated by rotation of the drive motor 45 is transferred to an axle and driving wheels W via a differential gear unit, for example.

The vehicle 400 also includes a regenerative brake mechanism (regenerator), though not illustrated. The regenerative brake mechanism rotates the drive motor 45 when the vehicle 400 is braked, and converts kinetic energy into regenerative energy, as electric energy. The regenerative energy, recovered in the regenerative brake mechanism, is inputted into the inverter 44 and converted to direct current. The converted direct current is inputted into the vehicle power source 41.

One terminal of a connecting line Li is connected to the negative electrode terminal 414 of the vehicle power source 41. The other terminal of the connecting line Li is connected to a negative electrode input terminal 417 of the inverter 44. A current detector (current detecting circuit) 416 in the battery management unit 411 is provided on the connecting line Li between the negative electrode terminal 414 and negative electrode input terminal 417.

One terminal of a connecting line L2 is connected to the positive electrode terminal 413 of the vehicle power source 41. The other terminal of the connecting line L2 is connected to a positive electrode input terminal 418 of the inverter 44. The switch unit 415 is provided on the connecting line L2 between the positive electrode terminal 413 and the positive electrode input terminal 418.

The external terminal 43 is connected to the battery management unit 411. The external terminal 43 can be connected, for example, to an external power source.

The vehicle ECU 42 performs cooperative control of the vehicle power source 41, the switch unit 415, the inverter 44, and the like, together with other management units and control units including the battery management unit 411 in response to inputs operated by a driver or the like. Through the cooperative control by the vehicle ECU 42 and the like, output of electric power from the vehicle power source 41, charge of the vehicle power source 41, and the like are controlled, thereby performing management of the whole vehicle 400. Data on the security of the vehicle power source 41, such as a remaining capacity of the vehicle power source 41, are transferred between the battery management unit 411 and the vehicle ECU 42 via communication lines.

The vehicle according to the fifth embodiment is mounted with the battery pack according to the fourth embodiment. Therefore, the vehicle has high cycle performance and output performance of the battery pack, and thus has high vehicle reliability.

### EXAMPLES

Examples will be described below, but the embodiments are not limited to the examples which will be described below.

### Example 1

### <Fabrication of First Particle>

As will be described below, first particles were fabricated by adding niobium titanium oxide particles into an inorganic particle-containing layer precursor solution and firing the mixture.

### <Preparation of First Solution>

1 g of nitric acid and 10 g of a 20 mass % polyvinyl alcohol solution were added to 500 mL of water, and the mixture was stirred with a stirrer for 10 minutes. 12 g of titanium tetraisopropoxide was added to the mixture, and the mixture was stirred for 1 hour. Further, 2.6 g of lithium nitrate, 9 g of ammonium dihydrogen phosphate and 4 g of aluminum nitrate nonahydrate were added to the mixture, and the mixture was stirred for 30 minutes. Thus, a first solution was obtained.

### <Formation of Inorganic Particle-Containing Layer>

The first solution provided above was provided as an inorganic particle-containing layer precursor solution. Niobium titanium oxide particles were added to the first solution. At this time, the niobium titanium oxide particles were added in a proportion such that the mass of an inorganic particle-containing layer obtained after firing was 3 mass % relative to the mass of the niobium-titanium oxide particles. This dispersion was stirred for 1 hour. After stirring, the dispersion was heated to 200° C. and evaporated to dryness to obtain a dry powder. The dry powder was transferred to an alumina crucible and fired at 700° C. for 8 hours in an electric furnace. Thus, first particles in which the inorganic particle-containing layer was formed on surfaces of the niobium titanium oxide particles were obtained. The inorganic particle-containing layer contained solid electrolyte-containing particles. The solid electrolyte was an oxide solid electrolyte having a composition represented by Li_{1.3}Al_{0.3}Ti_{1.7}(PO₄)₃. Thus, first particles were obtained.

### <Fabrication of Negative Electrode>

The first particles (88 mass %) as negative electrode active material particles, acetylene black (4 mass %) as an electro-conductive agent, carboxymethyl cellulose (CMC) (2 mass %) and styrene butadiene rubber (SBR) (2 mass %) as binders, and inorganic particles (4 mass %) were added to pure water as a solvent, and mixed. As the inorganic particles, particles having an average particle size of 0.5 μm and including a solid electrolyte were used. The solid electrolyte was an oxide solid electrolyte having a composition represented by Li_{1.3}Al_{0.3}Ti_{1.7}(PO₄)₃. The mixture was placed in a stirring container, glass beads of p 2 mm were further added so as to attain a filling rate of 60%, and the mixture was stirred at 1500 rpm for 3 minutes to obtain a slurry. The slurry after stirring was applied to one side of a current collector made of an aluminum foil having a thickness of 12 μm, and dried on a hot plate at 100° C. The slurry was also applied to the other side and dried on a hot plate at 100° C. Thereafter, pressing was performed to obtain a negative electrode. The obtained negative electrode was a double-sided negative electrode in which negative electrode active material-containing layers were formed on both sides of the current collector.

### <Fabrication of Positive Electrode>

Lithium nickel cobalt manganese composite oxide (LiNi_{0.8}Co_{0.1}Mn_{0.1}O₂) (90 mass %) as a positive electrode active material, acetylene black (5 mass %) as an electro-conductive agent, and polyvinylidene fluoride (PVdF) (5 mass %) as a binder were added to N-methylpyrrolidone (NMP) as a solvent, and mixed to prepare a slurry. The slurry was applied to one side of a current collector made of an aluminum foil having a thickness of 12 μm, and dried in a thermostatic bath at 120° C. Thereafter, pressing was performed to obtain a positive electrode. The obtained positive electrode was a single-sided positive electrode in which a positive electrode active material-containing layer was formed on one side of the current collector.

### <Fabrication of Electrode Group>

The single-sided positive electrode, a separator, the double-sided negative electrode, a separator, and the single-sided positive electrode were stacked in this order to obtain a stack. The single-sided positive electrode was stacked such that the side applied with the slurry faced the separator. As the separator, a polyethylene porous film having a thickness of 15 μm was used. An electrode group in a flat form was fabricated by heating and pressing the stack at 80° C. The obtained electrode group was housed in a pack made of a laminate film having a three-layer structure of nylon layer/aluminum layer/polyethylene layer and a thickness of 0.1 mm, and dried in vacuum at 120° C. for 16 hours.

### <Fabrication of Nonaqueous Electrolyte and Fabrication of Secondary Battery>

LiPF₆ as an electrolyte was dissolved, at a concentration of 1 mol/L, in a mixed solvent of propylene carbonate (PC) and diethyl carbonate (DEC) (volume ratio 1:2) to obtain a nonaqueous electrolyte. The preparation of the nonaqueous electrolyte was carried out in an argon box.

The nonaqueous electrolyte was injected into the laminate film pack housing the electrode group, and then the pack was completely sealed by heat-sealing. As a result, a secondary battery having a capacity of 300 mAh was obtained.

### Example 2

The proportion of the niobium titanium oxide particles added to the first solution was adjusted so that the mass of the inorganic particle-containing layer obtained after firing was 10 mass % relative to the mass of the niobium titanium oxide particles. In addition, the average particle size of the inorganic particles was changed to 1.0 μm. A secondary battery was fabricated in the same manner as in Example 1 except for the above.

### Example 3

The proportion of the niobium titanium oxide particles added to the first solution was adjusted so that the mass of the inorganic particle-containing layer obtained after firing was 0.5 mass % relative to the mass of the niobium titanium oxide particles. In addition, the average particle size of the inorganic particles was changed to 0.9 μm. A secondary battery was fabricated in the same manner as in Example 1 except for the above.

### Example 4

The proportion of the niobium titanium oxide particles added to the first solution was adjusted so that the mass of the inorganic particle-containing layer obtained after firing was 15 mass % relative to the mass of the niobium titanium oxide particles. In addition, the average particle size of the inorganic particles was changed to 0.9 μm. A secondary battery was fabricated in the same manner as in Example 1 except for the above.

### Example 5

The proportion of the niobium titanium oxide particles added to the first solution was adjusted so that the mass of the inorganic particle-containing layer obtained after firing was 0.05 mass % relative to the mass of the niobium titanium oxide particles. In addition, the average particle size of the inorganic particles was changed to 0.8 μm. A secondary battery was fabricated in the same manner as in Example 1 except for the above.

### Example 6

The average particle size of the inorganic particles was changed to 1.0 μm. A secondary battery was fabricated in the same manner as in Example 1 except for the above.

### Example 7

The average particle size of the inorganic particles was changed to 0.4 μm. A secondary battery was fabricated in the same manner as in Example 1 except for the above.

### Example 8

The average particle size of the inorganic particles was changed to 2.0 μm. A secondary battery was fabricated in the same manner as in Example 1 except for the above.

### Example 9

The average particle size of the inorganic particles was changed to 0.3 μm. A secondary battery was fabricated in the same manner as in Example 1 except for the above.

### Example 10

A secondary battery was fabricated in the same manner as in Example 2 except that, in the fabrication of the negative electrode, stirring was performed without adding glass beads.

### Example 11

As the inorganic particle-containing layer precursor solution, a commercially available 98% aluminum isopropoxide solution was provided instead of the first solution. In addition, the inorganic particles were changed to Al₂O₃ particles having an average particle size of 0.5 μm. A secondary battery was fabricated in the same manner as in Example 1 except for the above.

### Example 12

As the inorganic particle-containing layer precursor solution, a commercially available 97% titanium tetraisopropoxide solution was provided instead of the first solution. In addition, the inorganic particles were changed to TiO₂ particles having an average particle size of 0.5 μm. A secondary battery was fabricated in the same manner as in Example 1 except for the above.

### Example 13

As the inorganic particle-containing layer precursor solution, a commercially available 70% zirconium propoxide solution was provided instead of the first solution. In addition, the inorganic particles were changed to ZrO₂ particles having an average particle size of 0.5 μm. A secondary battery was fabricated in the same manner as in Example 1 except for the above.

### Example 14

As the inorganic particle-containing layer precursor solution, an aqueous magnesium sulfate solution was provided instead of the first solution. The aqueous magnesium sulfate solution was prepared as follows. To 100 g of water was added 20 g of magnesium sulfate heptahydrate, and the mixture was stirred to obtain an aqueous magnesium sulfate solution. In addition, the inorganic particles were changed to MgO particles having an average particle size of 0.5 μm. A secondary battery was fabricated in the same manner as in Example 1 except for the above.

### Comparative Example 1

Fabrication of the first particles was omitted. In the fabrication of the negative electrode, niobium titanium oxide particles were used as the negative electrode active material particles. A secondary battery was fabricated in the same manner as in Example 1 except for the above.

### Comparative Example 2

A secondary battery was fabricated in the same manner as in Example 1 except that the addition of inorganic particles was omitted in the fabrication of the negative electrode.

### Comparative Example 3

The proportion of the niobium titanium oxide particles added to the first solution was adjusted so that the mass of the inorganic particle-containing layer obtained after firing was 15 mass % relative to the mass of the niobium titanium oxide particles. In addition, the average particle size of the inorganic particles was changed to 0.5 μm. A secondary battery was fabricated in the same manner as in Example 1 except for the above.

### Comparative Example 4

Fabrication of the first particles was omitted. In the fabrication of the negative electrode, niobium titanium oxide particles were used as the negative electrode active material particles. In addition, the average particle size of the inorganic particles was changed to 1.0 μm. Further, 5 mass % of solid electrolyte-containing particles having an average particle size of 0.5 μm were added. The solid electrolyte was an oxide solid electrolyte represented by Li_{1.3}Al_{0.3}Ti_{1.7}(PO₄)₃.

The cycle performance and output performance of the fabricated secondary battery were evaluated by the following methods.

### <Cycle Test>

The obtained secondary batteries were charged to 3.0 V at a constant current of a 1 C rate at 25° C. Thereafter, the batteries were discharged to 1.5 V at a 1 C rate. The charge and discharge were defined as one cycle. The discharge capacity was measured at the time of discharge in the first cycle. Next, a total of 200 cycles of the above charge and discharge were repeated. The discharge capacity was measured at the time of discharge in the 200^{th} cycle. A value obtained by dividing the discharge capacity at the 200^{th} cycle by the discharge capacity at the first cycle and multiplying the obtained value by 100 was defined as capacity maintenance rate (%).

### <Discharge Performance Test at 0° C.>

After charge to 3.0 V at a constant current of a 1 C rate at 25° C., the batteries were discharged to 1.5 V at a 1 C rate at 0° C. The discharge capacity was measured at the time of discharge. The obtained discharge capacity was defined as discharge capacity (mAh) at 0° C.

The measurement results are shown in Table 1 below. The types and thicknesses of the inorganic particle-containing layers of the Comparative Examples in which the fabrication of the first particles was omitted, and the type and average particle size of the inorganic particles of the Comparative Example in which the inorganic particles were not added were indicated by “-”.

TABLE 1

| | | | | | | Discharge |
|---|---|---|---|---|---|---|
| | Type of inorganic | Thickness (μm) of | | Average particle | Capacity | capacity |
| | particle containing | inorganic particle- | Type of inorganic | size (μm) of | maintenance | (mAh) at |
| | layer | containing layer | particle | inorganic particle | rate (%) | 0° C. |
| Example 1 | Li_{1.3}Al_{0.3}Ti_{1.7}(PO₄)₃ | 0.05 | Li_{1.3}Al_{0.3}Ti_{1.7}(PO₄)₃ | 0.5 | 98.3 | 221 |
| Example 2 | Li_{1.3}Al_{0.3}Ti_{1.7}(PO₄)₃ | 0.4 | Li_{1.3}Al_{0.3}Ti_{1.7}(PO₄)₃ | 1.0 | 98.5 | 219 |
| Example 3 | Li_{1.3}Al_{0.3}Ti_{1.7}(PO₄)₃ | 0.0010 | Li_{1.3}Al_{0.3}Ti_{1.7}(PO₄)₃ | 0.9 | 97.6 | 230 |
| Example 4 | Li_{1.3}Al_{0.3}Ti_{1.7}(PO₄)₃ | 0.7 | Li_{1.3}Al_{0.3}Ti_{1.7}(PO₄)₃ | 0.9 | 98.5 | 200 |
| Example 5 | Li_{1.3}Al_{0.3}Ti_{1.7}(PO₄)₃ | 0.0005 | Li_{1.3}Al_{0.3}Ti_{1.7}(PO₄)₃ | 0.8 | 97.4 | 235 |
| Example 6 | Li_{1.3}Al_{0.3}Ti_{1.7}(PO₄)₃ | 0.05 | Li_{1.3}Al_{0.3}Ti_{1.7}(PO₄)₃ | 1.0 | 98.0 | 218 |
| Example 7 | Li_{1.3}Al_{0.3}Ti_{1.7}(PO₄)₃ | 0.05 | Li_{1.3}Al_{0.3}Ti_{1.7}(PO₄)₃ | 0.4 | 98.2 | 220 |
| Example 8 | Li_{1.3}Al_{0.3}Ti_{1.7}(PO₄)₃ | 0.05 | Li_{1.3}Al_{0.3}Ti_{1.7}(PO₄)₃ | 2.0 | 97.1 | 220 |
| Example 9 | Li_{1.3}Al_{0.3}Ti_{1.7}(PO₄)₃ | 0.05 | Li_{1.3}Al_{0.3}Ti_{1.7}(PO₄)₃ | 0.3 | 97.0 | 221 |
| Example 10 | Li_{1.3}Al_{0.3}Ti_{1.7}(PO₄)₃ | 0.7 | Li_{1.3}Al_{0.3}Ti_{1.7}(PO₄)₃ | 1.0 | 98.6 | 211 |
| Example 11 | Al₂O₃ | 0.05 | Al₂O₃ | 0.5 | 98.0 | 202 |
| Example 12 | TᵢO₂ | 0.05 | TᵢO₂ | 0.5 | 97.7 | 206 |
| Example 13 | ZrO₂ | 0.05 | ZrO₂ | 0.5 | 97.9 | 207 |
| Example 14 | MgO | 0.05 | MgO | 0.5 | 97.1 | 201 |
| Comparative Example 1 | — | — | Li_{1.3}Al_{0.3}Ti_{1.7}(PO₄)₃ | 0.5 | 91.1 | 202 |
| Comparative Example 2 | Li_{1.3}Al_{0.3}Ti_{1.7}(PO₄)₃ | 0.05 | — | — | 95.1 | 220 |
| Comparative Example 3 | Li_{1.3}Al_{0.3}Ti_{1.7}(PO₄)₃ | 0.7 | Li_{1.3}Al_{0.3}Ti_{1.7}(PO₄)₃ | 0.5 | 98.0 | 190 |
| Comparative Example 4 | — | — | Li_{1.3}Al_{0.3}Ti_{1.7}(PO₄)₃ | 1.0 | 94.3 | 224 |

All of the secondary batteries of the Examples including an electrode including inorganic particles and first particles in which the average particle size of the inorganic particles was larger than the thickness of the inorganic particle-containing layer had high values of both the capacity maintenance rate and the discharge capacity at 0° C. That is, both the cycle performance and the output performance were excellent.

In Comparative Examples 1 and 4 in which the fabrication of the first particles, that is, the formation of the inorganic particle-containing layer on the surfaces of the niobium titanium oxide particles was omitted, the capacity maintenance rate was a low value. This is considered to be because, when hydrofluoric acid not trapped by the inorganic particles approached the niobium titanium oxide particles, the hydrofluoric acid came into contact with the surfaces of the niobium titanium oxide particles, and, as a result, that the niobium titanium oxide particles were deteriorated, so that the cycle performance was reduced.

Comparative Example 4 is an example in which solid electrolyte-containing particles were further added instead of omitting the formation of the inorganic particle-containing layer, but the cycle performance was lower than those in the Examples. From this fact, it is considered that, when the solid electrolyte-containing particles are not formed in layers on the surfaces of the niobium titanium oxide particles, that is, when the solid electrolyte-containing particles are present away from the niobium titanium oxide particles, the effect for suppressing contact of hydrofluoric acid with the niobium titanium oxide particles is low.

In Comparative Example 2 in which the addition of the inorganic particles was omitted, the capacity maintenance rate was a low value. This is considered to be because hydrofluoric acid was not trapped by the inorganic particles in the electrode of Comparative Example 2, and thus the amount of hydrofluoric acid approaching the first particles in the electrode was larger than that in the electrodes of the Examples. As a result, it is considered that the amount of hydrofluoric acid in contact with the surfaces of the niobium titanium oxide particles increased, for example, from the exposed portion of the first particles. In addition, it is considered that the amount of hydrofluoric acid in contact with the niobium titanium oxide particles increased as hydrofluoric acid in an amount exceeding the amount of hydrofluoric acid that could be trapped by the inorganic particle-containing layer approached the first particles. As a result, it is considered that the niobium titanium oxide was deteriorated, and thus that the cycle performance was reduced.

In Comparative Example 3 in which the thickness of the inorganic particle-containing layer was larger than the average particle size of the inorganic particles, the discharge capacity at 0° C. was lower than those in the Examples. That is, the output performance was lower than those in the Examples. In Comparative Example 3, it is considered that, since the average particle size of the inorganic particles was relatively small as compared with the thickness of the inorganic particle-containing layer, the dispersibility of the inorganic particles and the electro-conductive agent in the manufacturing process of the electrode was reduced, so that the uniformity of the presence of the inorganic particles and the electro-conductive agent in the electrode was reduced. The active material particles of Comparative Example 3 have relatively low electron conductivity since the thickness of the inorganic particle-containing layer is larger than the average particle size of the inorganic particles. Accordingly, it is considered that the output performance in Comparative Example 3 was reduced.

When Examples 1 to 3 were compared with Example 4 in which the thickness of the inorganic particle-containing layer was 0.7 μm, Examples 1 to 3 had a particularly high discharge capacity at 0° C. This is considered to be because, in Examples 1 to 3, the thickness of the inorganic particle-containing layer was 0.4 μm or less, and thus that the effect for suppressing an increase in resistance was high. Therefore, it has become clear that the electrode including the first particles in which the thickness of the inorganic particle-containing layer is 0.4 μm or less is particularly excellent in output performance.

In addition, when Examples 1 to 3 were compared with Example 5 in which the thickness of the inorganic particle-containing layer was 0.0005 μm, Examples 1 to 3 had a particularly high capacity maintenance rate. This is considered to be because the inorganic particle-containing layer had a thickness of 0.0010 μm or more, and thus provided high durability against hydrofluoric acid in Examples 1 to 3. Therefore, it has become clear that the electrode including the first particles in which the thickness of the inorganic particle-containing layer is 0.0010 μm or more is particularly excellent in cycle performance.

When Examples 1, 6, and 7 are compared with Example 8 in which the average particle size of the inorganic particles was 2.0 μm and Example 9 in which the average particle size of the inorganic particles was 0.3 μm, the capacity maintenance rates of Examples 1, 6, and 7 were particularly high. From this result, it is considered that the inorganic particles having an average particle size of 0.4 μm or more and 1.0 μm or less included in Examples 1, 6, and 7 fall within a range of an inorganic particle size suitable for exhibiting hydrofluoric acid trapping ability. Therefore, it has become clear that the electrode in which the average particle size of the inorganic particles is in the range of 0.4 μm or more and 1.0 μm or less is particularly excellent in cycle performance.

Example 10 is a secondary battery fabricated in the same manner as in Example 2 except that stirring was performed without adding glass beads in the fabrication of the negative electrode. It is considered that, in the first particles included in Example 2 in which glass beads were added during stirring, a part of the surfaces of the niobium titanium oxide particles was exposed by scraping a part of the surface of the inorganic particle-containing layer. That is, it is considered that the first particles of Example 2 were the first particles including the exposed portion. In such Example 2, the discharge capacity at 0° C. was particularly high as compared with Example 10 in which glass beads were not added at the time of stirring. From this fact, it has become clear that the electrode including the first particles having the exposed portion is particularly excellent in output performance.

Example 11 is an electrode in which the inorganic particle-containing layer includes particles including a metal oxide containing Al, and includes Al₂O₃ particles as the inorganic particles. Example 12 is an electrode in which the inorganic particle-containing layer includes particles including a metal oxide containing Ti, and includes TiO₂ particles as the inorganic particles. Example 13 is an electrode in which the inorganic particle-containing layer includes particles including a metal oxide containing Zr, and includes ZrO₂ particles as the inorganic particles. Example 14 is an electrode in which the inorganic particle-containing layer includes particles including a metal oxide containing Mg, and includes MgO particles as the inorganic particles. In such Examples 11 to 14, both the capacity maintenance rate and the discharge capacity at 0° C. were high values. That is, both the cycle performance and the output performance were excellent.

From this fact, it became clear that the cycle performance and the output performance can be improved also in a case where the inorganic particle-containing layer includes particles including a metal oxide containing at least one element selected from the group consisting of Al, Ti, Zr, and Mg. Further, it became clear that the cycle performance and the output performance can be improved also in a case where the inorganic particles include a metal oxide containing at least one element selected from the group consisting of Al, Ti, Zr, and Mg.

According to at least one of the embodiments described above, an electrode is provided. The electrode includes: inorganic particles; niobium titanium oxide particles; and an inorganic particle-containing layer covering at least a part of surfaces of the niobium titanium oxide particles. An average particle size of the inorganic particles is larger than a thickness of the inorganic particle-containing layer. Therefore, the electrode can have improved cycle performance and output performance.

Hereinafter, the inventions according to the embodiments will be additionally described.
<1> An electrode including: inorganic particles; niobium titanium oxide particles; and an inorganic particle-containing layer covering at least a part of surfaces of the niobium titanium oxide particles,
wherein an average particle size of the inorganic particles is larger than a thickness of the inorganic particle-containing layer.
<2> The electrode according to <1>, wherein the thickness of the inorganic particle-containing layer is in a range of 0.001 μm or more and 0.4 μm or less.
<3> The electrode according to <1> or <2>, wherein the average particle size of the inorganic particles is in a range of 0.4 μm or more and 1 μm or less.
<4> The electrode according to any one of <1> to <3>, wherein the inorganic particle-containing layer covers a part of surfaces of the niobium titanium oxide particles, and at least a part of a portion other than the part of surfaces of the niobium titanium oxide particles is exposed on a surface of the electrode.
<5> The electrode according to any one of <1> to <4>, wherein the inorganic particles include at least one selected from the group consisting of a solid electrolyte, and a metal oxide containing at least one element selected from the group consisting of Al, Ti, Si, Zr, and Mg.
<6> The electrode according to any one of <1> to <5>, wherein the inorganic particle-containing layer includes at least one selected from the group consisting of solid electrolyte-containing particles, and particles including a metal oxide containing at least one element selected from the group consisting of Al, Ti, Si, Zr, and Mg.
<7> The electrode according to any one of <1> to <6>, wherein the inorganic particles include a solid electrolyte, and the inorganic particle-containing layer includes solid electrolyte-containing particles.
<8> A secondary battery including: a positive electrode; a negative electrode; and a nonaqueous electrolyte,
wherein the nonaqueous electrolyte includes a fluorine atom, and
at least one of the positive electrode and the negative electrode is the electrode according to any one of <1> to <7>.
<9> A battery pack including the secondary battery according to <8>.
<10> The battery pack according to <9>, further including:
an external power distribution terminal; and
a protective circuit.
<11> The battery pack according to <9> or <10>, further including a plurality of the secondary battery, the plurality of the secondary battery being electrically connected in series, in parallel, or in a combination of in series and in parallel.
<12> A vehicle including the battery pack according to any one of <9> to <11>.
<13> The vehicle according to <12>, including a mechanism that converts kinetic energy of the vehicle into regenerative energy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electrode comprising: inorganic particles;
niobium titanium oxide particles; and an inorganic particle-containing layer covering at least a part of surfaces of the niobium titanium oxide particles,
wherein an average particle size of the inorganic particles is larger than a thickness of the inorganic particle-containing layer.

2. The electrode according to claim 1, wherein the thickness of the inorganic particle-containing layer is in a range of 0.001 μm or more and 0.4 μm or less.

3. The electrode according to claim 1, wherein the average particle size of the inorganic particles is in a range of 0.4 μm or more and 1 μm or less.

4. The electrode according to claim 1, wherein the inorganic particle-containing layer covers a part of surfaces of the niobium titanium oxide particles, and at least a part of a portion other than the part of surfaces of the niobium titanium oxide particles is exposed on a surface of the electrode.

5. The electrode according to claim 1, wherein the inorganic particles comprise at least one selected from the group consisting of a solid electrolyte, and a metal oxide containing at least one element selected from the group consisting of Al, Ti, Si, Zr, and Mg.

6. The electrode according to claim 1, wherein the inorganic particle-containing layer comprises at least one selected from the group consisting of solid electrolyte-containing particles, and particles comprising a metal oxide containing at least one element selected from the group consisting of Al, Ti, Si, Zr, and Mg.

7. The electrode according to claim 1, wherein the inorganic particles comprise a solid electrolyte, and the inorganic particle-containing layer comprises solid electrolyte-containing particles.

8. A secondary battery comprising: a positive electrode; a negative electrode; and a nonaqueous electrolyte,
wherein the nonaqueous electrolyte comprises a fluorine atom, and
at least one of the positive electrode and the negative electrode is the electrode according to claim 1.

9. A battery pack comprising the secondary battery according to claim 8.

10. The battery pack according to claim 9, further comprising:
an external power distribution terminal; and
a protective circuit.

11. The battery pack according to claim 9, further comprising a plurality of the secondary battery, the plurality of the secondary battery being electrically connected in series, in parallel, or in a combination of in series and in parallel.

12. A vehicle comprising the battery pack according to claim 9.

13. The vehicle according to claim 12, comprising a mechanism that converts kinetic energy of the vehicle into regenerative energy.
